(19) United States
(12) Patent Application Publication
(10) Pub. No.: US 2003/0163593 A1
(43) Pub. Date: Aug. 28, 2003

(54) Method and system for implementing a fair, high-performance protocol for resilient packet ring networks

(75) Inventor: Edward Knightly, Houston, TX (US)

Correspondence Address: BAKER BOTTS, LLP, 910 LOUISIANA, HOUSTON, TX, 77002-4995, US

(73) Assignee: William March Rice University

(21) Appl. No.: 10/374,232

(22) Filed: Feb. 25, 2003

Related U.S. Application Data
(60) Provisional application No. 60/359,386, filed on Feb. 25, 2002.

(51) Int. Cl. G06F 15/16

(52) U.S. Cl. 709/251; 709/232

(57) ABSTRACT

A system and method for dynamic bandwidth allocation is provided. The method provides one or more nodes to compute a simple lower bound of temporally and spatially aggregated virtual time using per-ingress counters of packet (byte) arrivals. Thus, when information is propagated along the ring, each node can remotely approximate the ideal fair rate for its own traffic at each downstream link. In this way, flows on the ring rapidly converge to their ring-wide fair rates while maximizing spatial reuse.

### CROSS REFERENCE TO RELATED APPLICATION

This application is a conversion of U.S. Provisional Application No. 60/359,386 entitled “DESIGN, ANALYSIS, AND IMPLEMENTATION OF DISTRIBUTED VIRTUAL TIME SCHEDULING IN RINGS: AN ENHANCED PROTOCOL FOR PACKET RINGS” that was filed on Feb. 25, 2002.

### BACKGROUND OF THE INVENTION

1. Field of the Invention

The present invention is related to computer networks. More specifically, the present invention is related to a fair, high performance protocol for packets on a distributed virtual-time scheduling of bandwidth within a resilient packet ring.

2. Description of the Related Art

The overwhelmingly prevalent topology for metro networks is a ring. The primary reason is fault tolerance: all nodes remain connected with any single failure of a bi-directional link span. Moreover, rings have reduced deployment costs as compared to star or mesh topologies as ring nodes are only connected to their two nearest neighbors vs. to a centralized point (star) or multiple points (mesh).

Unfortunately, current technology choices for high-speed metropolitan ring networks provide a number of unsatisfactory alternatives. A SONET ring can ensure minimum bandwidths (and hence fairness) between any pair of nodes. However, use of circuits prohibits unused bandwidth from being reclaimed by other flows and results in low utilization. On the other hand, a Gigabit Ethernet (GigE) ring can provide full statistical multiplexing, but suffers from unfairness as well as bandwidth inefficiencies due to forwarding all traffic in the same direction around the ring as dictated by the spanning tree protocol. For example, in the topology of FIG. 1, GigE nodes 104 will obtain different throughputs to the core or hub node 120 depending on their spatial location on the ring (meaning whether they are connected to core nodes 120-130). For example, the wide area network 106 would experience different performance because it is connected to core node 124 than the GigE nodes 104 because they are connected to a different core node 120. Finally, legacy technologies such as FDDI and DQDB do not employ spatial reuse. For example, FDDI's use of a rotating token requires that only one node can transmit at a time.

### SUMMARY OF THE INVENTION

The IEEE 802.17 Resilient Packet Ring (RPR) working group was formed in early 2000 to develop a standard for bi-directional packet metropolitan rings. Unlike legacy technologies, the protocol supports destination packet removal so that a packet will not traverse all ring nodes and spatial reuse can be achieved. However, allowing spatial reuse introduces a challenge to ensure fairness among different nodes competing for ring bandwidth. Consequently, the key performance objective of RPR is to simultaneously achieve high utilization, spatial reuse, and fairness. Additional objectives of the present invention is a 50 msec fault recovery similar to that of SONET.

To illustrate spatial reuse and fairness, consider the depicted scenario in FIG. 2 in which four infinite demand flows share link 4 in route to destination node 5. In this “parallel parking lot” example, each of these flows should receive ¼ of the link bandwidth to ensure fairness. Moreover, to fully exploit spatial reuse, flow (1,2) should receive all excess capacity on link 1, which is ¾ due to the downstream congestion.

The key technical challenge of RPR is design of a bandwidth allocation algorithm that can dynamically achieve such rates. Note that to realize this goal, some coordination among nodes is required. For example, if each node performs weighted fair queuing a local operation without coordination among nodes, flows (1,2) and (1,5) would obtain equal bandwidth shares at node I so that flow (1,2) would receive a net bandwidth of ½ vs. the desired ¾. Thus, RPR algorithms must throttle traffic at ingress points based on downstream traffic conditions to achieve these rate allocations.

The RPR standard defines a fairness algorithm that specifies how upstream traffic should be throttled according to downstream measurements, namely, how a congested node will send fairness messages upstream so that upstream nodes can appropriately configure their rate limiters to throttle the rate of injected traffic to its fair rate. The standard also defines the scheduling policy to arbitrate service among transit and station (ingress) traffic as well as among different priority classes. The RPR fairness algorithm has several modes of operation including aggressive/conservative modes for rate computation and single-queue and dual-queue buffering for transit traffic.

Unfortunately, we have found that the RPR fairness algorithm has a number of important performance limitations. First, it is prone to severe and permanent oscillations in the range of the entire link bandwidth in simple “unbalanced traffic” scenarios in which all flows do not demand the same bandwidth. Second, it is not able to fully achieve spatial reuse and fairness. Third, for cases where convergence to fair rates does occur, it requires numerous fairness messages to converge (e.g., 500) thereby hindering fast responsiveness.

The goals of this discussion are threefold. In the detailed description of the invention, we first provide an idealized reference model termed Ring Ingress Aggregated with Spatial reuse (RIAS) fairness. RIAS fairness achieves maximum spatial reuse subject to providing fair rates to each ingress-aggregated flow at each link. We argue that this fairness model addresses the specialized design goals of metro rings, whereas proportional fairness and flow max-min fairness do not. We use this model to identify key problematic scenarios for RPR algorithm design, including those studied in the standardization process (e.g., “Parking Lot”) and others that have not received previous attention (e.g., “Parallel Parking Lot” and “Unbalanced Traffic”). We then use the reference model and these scenarios as a benchmark for evaluating and comparing fairness algorithms, and to identify fundamental limits of current RPR control mechanisms.

Second, we develop a new dynamic bandwidth allocation algorithm termed Distributed Virtual-time Scheduling in Rings (DVSR). Like current implementations, DVSR has a simple transit path without any complex operations such as fair queuing. However, with DVSR, each node uses its per-destination byte counters to construct a simple lower bound on the evolution of the spatially and temporally aggregated virtual time. That is, using measurements available at an RPR node, we compute the minimum cumulative change in virtual time since the receipt of the last control message, as if the node was performing weighted fair queuing at the granularity of ingress-aggregated traffic. By distributing such control information upstream, we show how nodes can perform simple operations on the collected information and throttle their ingress flows to their ring-wide RIAS fair rates.

Finally, we study the performance of DVSR and the standard RPR fairness algorithm using a combination of theoretical analysis, simulation, and implementation. In particular, we analytically bound DVSR's unfairness due to use of delayed and time-averaged information in the control signal. We perform ns-2 simulations to compare fairness algorithms and obtain insights into problematic scenarios and sources of poor algorithm performance. For example, we show that while DVSR can fully reclaim unused bandwidth in scenarios with unbalanced traffic (unequal input rates), the RPR fairness algorithm suffers from utilization losses of up to 33% in an example with two links and two flows. We also show how DVSR's RIAS fairness mechanism can provide performance isolation among nodes' throughputs. For example, in a Parking Lot scenario (FIG. 5) with even moderately aggregated TCP flows from one node competing for bandwidth with non-responsive UDP flows from other nodes, all ingress nodes obtain nearly equal throughput shares with DVSR, quite different from the unfair node throughputs obtained with a GigE ring. Finally, we develop a 1 Gb/sec network processor implementation of DVSR and present the results of our measurement study on an eight-node ring.

The remainder of this discussion is organized as follows. In Section II we present an overview of the RPR node architecture and fairness algorithms. Next, in Section III we present the RIAS reference model for fairness. In Section IV, we present a performance analysis of the RPR algorithms and present oscillation conditions and expressions for throughput degradation. In Section V, we present the DVSR algorithm and in Section VI we analyze DVSR's fairness properties. Next, we provide extensive simulation comparisons of DVSR, RPR, and GigE in Section VII, and in Section VIII, we present measurement studies from our network processor implementation of DVSR. Finally, we review related work in Section IX and conclude in Section X.

### BRIEF DESCRIPTION OF THE DRAWINGS

A more complete understanding of the present disclosures and advantages thereof may be acquired by referring to the following description taken in conjunction with the accompanying drawings wherein:

FIG. 1 is an illustration of a resilient packet ring according to the prior art.

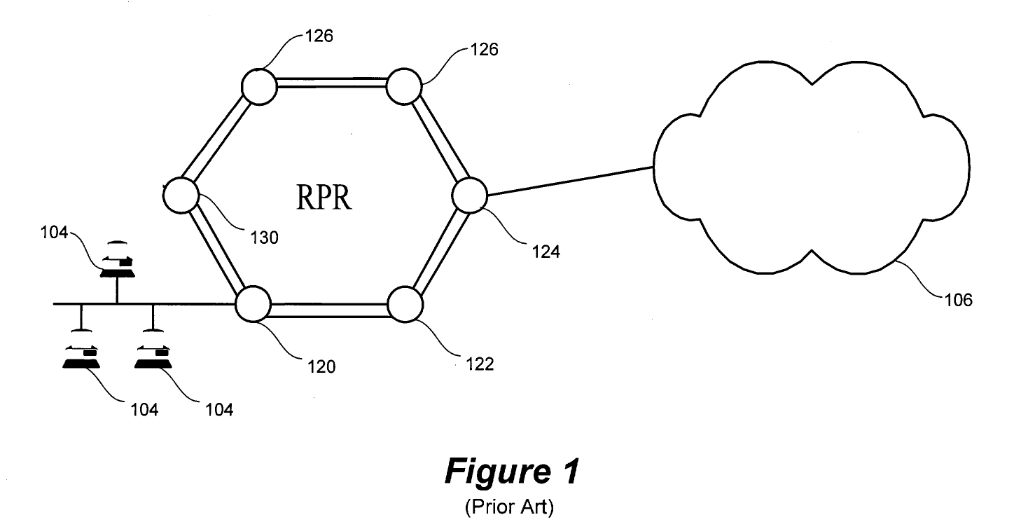

FIG. 2 is a block diagram illustrating a parallel parking lot flow problem according to the prior art.

FIG. 3 is a block diagram illustrating a generic resilient packet ring node architecture according to the teachings of the present invention.

FIG. 4 is a block diagram illustrating a parallel parking lot flow situation implementing a ring ingress aggregated with spatial reuse (RIAS) fairness according to the teachings of the present invention.

FIG. 5 is a block diagram illustrating a parallel parking lot topology according to the teachings of the present invention.

FIG. 6 is a block diagram illustrating a tow-exit parking lot topology according to the teachings of the present invention.

FIG. 7 is a block diagram of an oscillation scenario according to the teachings of the present invention.

FIG. 8 is a block diagram of an upstream parallel parking lot situation according to the teachings of the present invention.

FIG. 9a is a plot of throughput versus time for a resilient packet ring (RSR) in aggressive mode according to the teachings of the present invention.

FIG. 9b is a plot of throughput versus time for a resilient packet ring in conservative mode according to the teachings of the present invention.

FIG. 10 is a plot of throughput loss versus flow rate for a resilient packet ring in aggressive mode according to the teachings of the present invention.

FIG. 11 is a plot of throughput loss versus flow rate for a resilient packet ring in conservative mode according to the teachings of the present invention.

FIG. 12 is a plot of remote fair queuing according to the teachings of the present invention.

FIG. 13a is a plot of packet size versus traffic arrival for a first flow according to the teachings of the present invention.

FIG. 13b is a plot of packet size versus traffic arrival for a second flow according to the teachings of the present invention.

FIG. 13c is a plot of packet size versus virtual time according to the teachings of the present invention.

FIG. 14 is a block diagram illustrating a single node model for a distributed virtual-time scheduling in rings (DVSR) according to the teachings of the present invention.

FIG. 15 is a plot of fairness versus time illustrating the fairness bound according to the teachings of the present invention.

FIG. 16 is a plot of normalized throughput versus flow for a parking lot example according to the teachings of the present invention.

FIG. 17 is a plot of normalized throughput versus flow for a DVSR's TCP and UDP flow bandwidth shares according to the teachings of the present invention.

FIG. 18 is a plot of normalized throughput versus flow illustrating a DVSR's throughput for TCP micro-flows according to the teachings of the present invention.

FIG. 19 is a plot of normalized throughput versus flow illustrating the spatial reuse in the parallel parking lot example according to the teachings of the present invention.

FIG. 20 illustrates convergence times for the DVSR, and the resilient packet ring in both aggressive mode and conservative mode according to the teachings of the present invention.

FIG. 21 is a block diagram illustrating the testbed configuration according to the teachings of the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention, as defined by the appended claims, are to be covered.

### DETAILED DESCRIPTION OF THE INVENTION

II. BACKGROUND ON IEEE 802.17 RPR

In this section, we describe the basic operation of the Resilient Packet Ring (RPR) fairness algorithm. Due to space constraints, our description necessarily omits many details and focuses on the key mechanisms for bandwidth arbitration. Readers are referred to the standards documents for full details and pseudocode.

Throughout, we consider committed rate (Class B) and best effort (Class C) traffic classes in which each node obtains a minimum bandwidth share (zero for Class C) and reclaims unused bandwidth in a weighted fair manner, here considering equal weights for each node. We omit discussion of Class A traffic that has guaranteed rate and jitter, as other nodes are prohibited from reclaiming unused Class A bandwidth.

A. RPR Node Architecture

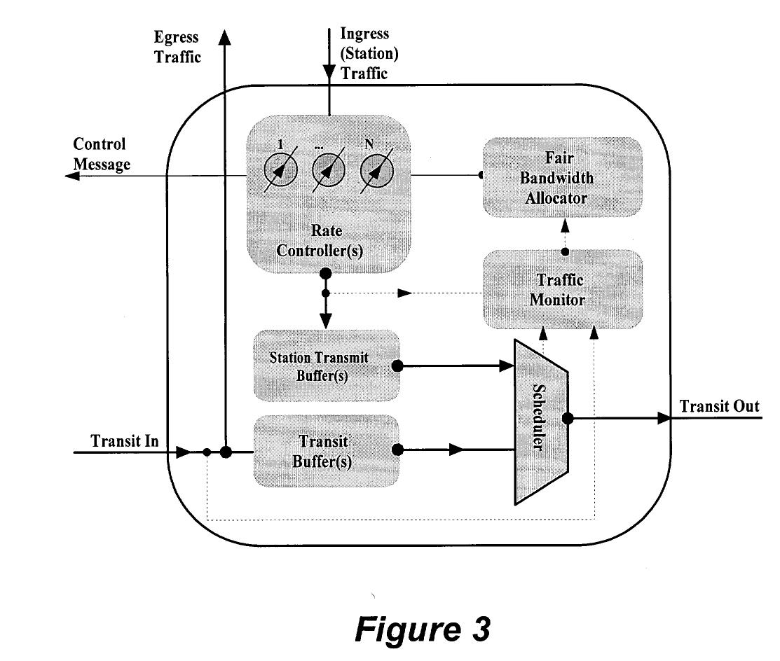

The architecture of a generic RPR node is illustrated in FIG. 3. For convenience, the generic RPR node 300 is implemented on a network processor 302, although it could also be implemented in hardware, such as on an ASIC. The generic RPR node 300 contains one or more rate controllers 304. The rate controllers 304 receive ingress station traffic as illustrated in FIG. 3. The node 300 also contains a fair bandwidth allocator 306 that is operative with the rate controllers 304. One or more station transmit buffers 314 are also provided for the node 300. The station transmit buffers 314 receive signals from the rate controllers 304 and, along with the one or more transit buffers 312, provides signals to the scheduler 310. The transit buffers 312 receive transit in signals as illustrated in FIG. 3. Transit in signals may also be forwarded to the traffic monitor 308, the latter of which can also receive signals from the scheduler 310. The traffic monitor 308, therefor, can receives signals from the rate controllers 304, the transit buffers 312, and the scheduler 310 before providing any output to the fair bandwidth allocator 306. Control message signals can be released by the rate controllers 304 as illustrated in FIG. 3. Moreover, egress traffic and transit out signals can also emanate from the node 300 as illustrated in FIG. 3. First, observe that all station traffic entering the ring is first throttled by rate controllers 304. In the example of the Parallel Parking Lot, it is clear that to fully achieve spatial reuse, flow (1,5) must be throttled to rate ¼ at its ring ingress point. Second, these rate controllers 304 are at a per-destination granularity. This allows a type of virtual output queuing analogous to that performed in switches to avoid head-of-line blocking, i.e., if a single link is congested, an ingress node should only throttle its traffic forwarded over that link.

Next, RPR nodes have measurement modules (byte counters) to measure demanded and/or serviced station and transit traffic. These measurements are used by the fairness algorithm to compute a feedback control signal to throttle upstream nodes to the desired rates. Nodes that receive a control message use the information in the message, perhaps together with local information, to set the bandwidths for the rate controllers 304 (see FIG. 3).

The final component is the scheduling algorithm that arbitrates service among station and transit traffic. In single-queue mode, the transit path consists of a single FIFO queue referred to as the Primary Transit Queue (PTQ). In this case, the scheduler employs strict priority of transit traffic over station traffic. In dual-queue mode, there are two transit path queues, one for guaranteed Class A traffic (PTQ), and the other for Class B and C traffic, called Secondary Transit Queue (STQ). In this mode, the scheduler always services Class A transit traffic first from PTQ. If this queue is empty, the scheduler employs round-robin service among the transit traffic in STQ and the station traffic until a buffer threshold is reached for STQ. If STQ reaches the buffer threshold, STQ transit traffic is always selected over station traffic to ensure a lossless transit path. In other words, STQ has strict priority over station traffic once the buffer threshold is crossed; otherwise, service is round robin among transit and station traffic.

In both cases, the objective is to ensure hardware simplicity (for example, avoiding expensive per-flow or per-ingress queues on the transit path) and to ensure that the transit path is lossless, i.e., once a packet is injected into the ring, it will not be dropped at a downstream node.

B. RPR Fairness Algorithm

The dynamic bandwidth control algorithm that determines the station rate controller values, and hence the basic fairness and spatial reuse properties of the system is the primary aspect in which the RPR fairness algorithm and DVSR differ and is the focus of the discussion below as well as throughout the discussion.

There are two modes of operation for the RPR fairness algorithm. The first, termed Aggressive Mode (AM), evolved from the Spatial Reuse Protocol (SRP) currently deployed in a number of operational metro networks. The second, termed Conservative Mode (CM), evolved from the Aladdin algorithm. Both modes operate within the same framework described as follows. A congested downstream node conveys its congestion state to upstream nodes such that they will throttle their traffic and ensure that there is sufficient spare capacity for the downstream station traffic. To achieve this, a congested node transmits its local fair rate upstream, and all upstream nodes sending to the link must throttle to this same rate. After a convergence period, congestion is alleviated once all nodes' rates are set to the minimum fair rate. Likewise, when congestion clears, stations periodically increase their sending rates to ensure that they are receiving their maximal bandwidth share.

There are two key measurements for RPR's bandwidth control, forward_rate and add_rate. The former represents the service rate of all transit traffic and the latter represents the rate of all serviced station traffic. Both are measured as byte counts over a fixed interval length aging_interval. Moreover, both measurements are low-pass-filtered using exponential averaging with parameter 1/LPCOEF given to the current measurement and 1-1/LPCOEF given to the previous average. In both cases, it is important that the rates are measured at the output of the scheduler so that they represent serviced rates rather than offered rates.

At each aging_interval, every node checks its congestion status based on conditions specific to the mode AM or CM. When node n is congested, it calculates its local_fair_rate[n], which is the fair rate that an ingress-based flow can transmit to node n. Node n then transmits a fairness control message to its upstream neighbor that contains local_fair_rate [n].

If upstream node (n-1) receiving the congestion message from node n is also congested, it will propagate the message upstream using the minimum of the received local_fair_rate [n] and its own local_fair_rate [n-1]. The objective is to inform upstream nodes of the minimum rate they can send along the path to the destination. If node (n-1) is not congested but its forward_rate is greater than the received local_fair_rate [n], it forwards the fairness control message containing local_fair rate [n] upstream, as this situation indicates that the congestion is due to transit traffic from further upstream. Otherwise, a null-value fairness control message is transmitted to indicate a lack of congestion.

When an upstream node i receives a fairness control message advertising local_fair_rate [n], it reduces its rate limiter values, termed allowed_rate [i][j], for all values of j, such that n lies on the path from i to j. The objective is to have upstream nodes throttle their own station rate controller values to the minimum rate it can send along the path to the destination. Consequently, station traffic rates will not exceed the advertised local_fair_rate value of any node in the downstream path of a flow. Otherwise, if a null-value fairness control message is received, it increments allowed_rate by a fixed value such that it can reclaim additional bandwidth if one of the downstream flows reduces its rate. Moreover, such rate increases are essential for convergence to fair rates even in cases of static demand.

The main differences between AM and CM are congestion detection and calculation of the local fair rate which we discuss below. Moreover, by default AM employs dual-queue mode and CM employs single-queue mode.

C. Aggressive Mode (AM)

Aggressive Mode is the default mode of operation of the RPR fairness algorithm and its logic is as follows. An AM node n is said to be congested whenever

STQ_depth[n]>low_threshold

or

forward_rate[n]+add_rate[n]>unreserved_rate,

where as above, STQ is the transit queue for Class B and C traffic. The threshold value low_threshold is a fraction of the transit queue size with a default value of ⅛ of the STQ size. The unreserved_rate is the link capacity minus the reserved rate for guaranteed traffic. As we consider only best-effort traffic, unreserved_rate is the link capacity used for the remainder of this discussion.

When a node is congested, it calculates its local_fair_rate as the normalized service rate of its own station traffic, add_rate, and then transmits a fairness control message containing add_rate to upstream nodes.

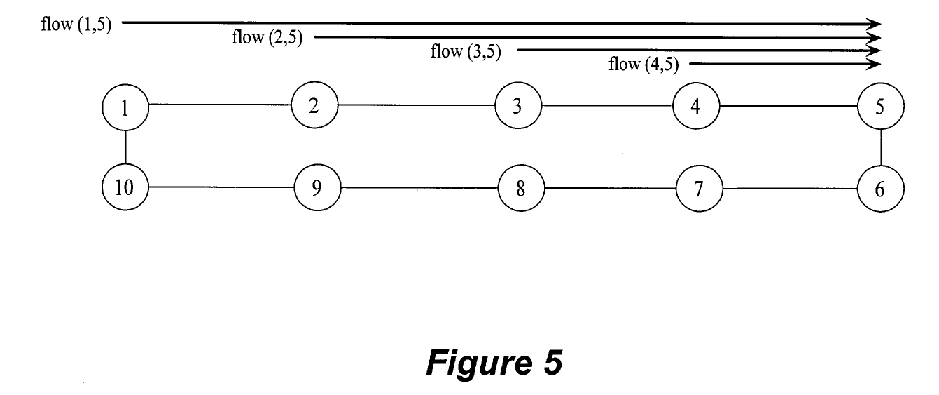

Considering the parking lot example in FIG. 5, if a downstream node advertises add_rate below the true fair rate (which does indeed occur before convergence), all upstream nodes will throttle to this lower rate; in this case, downstream nodes will later become uncongested so that flows will increase their allowed_rate. This process will then oscillate more and more closely around the targeted fair rates for this example.

D. Conservative Mode (CM)

Each CM node has an access timer measuring the time between two consecutive transmissions of station packets. As CM employs strict priority of transit traffic over station traffic via single queue mode, this timer is used to ensure that station traffic is not starved. Thus, a CM node n is said to be congested if the access timer for station traffic expires or if

forward_rate[n]+add_rate[n]>low threshold.

Unlike AM, low_threshold for CM is a rate-based parameter that is a fixed value less than the link capacity, 0.8 of the link capacity by default. In addition to measuring forward_rate and add_rate, a CM node also measures the number of active stations that have had at least one packet served in the past aging_interval.

If a CM node is congested in the current aging_interval, but was not congested in the previous one, the local_fair_rate is computed as the total unreserved rate divided by the number of active stations. If the node is continuously congested, then local_fair_rate depends on the sum of forward_rate and add_rate. If this sum is less than low_threshold, indicating that the link is under utilized, local_fair_rate ramps up. If this sum is above high_threshold, a fixed parameter with a default value that is 0.95 of the link capacity, local_fair_rate will ramp down.

Again considering the parking lot example in FIG. 5, when the link between nodes 4 and 5 is first congested, node 4 propagates rate ¼, the true fair rate. At this point, the link will still be considered congested because its total rate is greater than low_threshold. Moreover, because the total rate is also greater than high_threshold, local_fair_rate will ramp down periodically until the sum of add_rate and forward_rate at node 4 is less than high_threshold but greater than low_threshold. Thus, for CM, the maximum utilization of the link will be high_threshold, hence the name “conservative.”

III. A FAIRNESS REFERENCE MODEL FOR PACKET RINGS

For flows contending for bandwidth at a single network node, a definition of fairness is immediate and unique. However, for multiple nodes, there are various bandwidth allocations that can be considered to be fair in different senses. For example, proportional fairness allocates a proportionally decreased bandwidth to flows consuming additional resources, i.e., flows traversing multiple hops, whereas max-min fairness does not. Moreover, any definition of fairness must carefully address the granularity of flows for which bandwidth allocations are defined. Bandwidth can be granted on a per-micro-flow basis or alternately to particular groups of aggregated micro-flows.

In this section, we define Ring Ingress Aggregated with Spatial Reuse (RIAS) fairness, a reference model for achieving fair bandwidth allocation while maximizing spatial reuse in packet rings. The RIAS reference model is now incorporated into the IEEE 802.17 standard's targeted performance objective. We justify the model based on the design goals of packet rings and compare it with proportional and max-min fairness. We then use the model as a design goal in DVSR's algorithm design and the benchmark for general RPR performance analysis.

A. Ring Ingress Aggregated with Spatial Reuse (RIAS) Fairness

RIAS Fairness has two key components. The first component defines the level of traffic granularity for fairness determination at a link as an ingress-aggregated (IA) flow, i.e., the aggregate of all flows originating from a given ingress node, but not necessarily destined to a single egress node. The targeted service model of packet rings justifies this: to provide fair and/or guaranteed bandwidth to the networks and backbones that it interconnects. Thus, our reference model ensures that an ingress node's traffic receives an equal share of bandwidth on each link relative to other ingress nodes' traffic on that link. The second component of RIAS fairness ensures maximal spatial reuse subject to this first constraint. That is, bandwidth can be reclaimed by IA flows (that is, clients) when it is unused either due to lack of demand or in cases of sufficient demand in which flows are bottlenecked elsewhere.

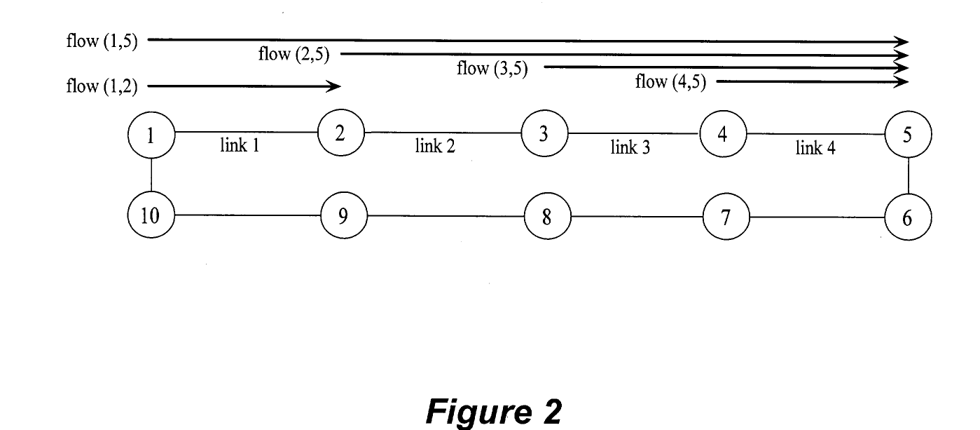

Below, we present a formal definition that determines if a set of candidate allocated rates (expressed as a matrix R) is RIAS fair. For simplicity, we define RIAS fairness for the case that all ingress nodes have equal weight; the definition can easily be generalized to include weighted fairness. Furthermore, for ease of discussion and without loss of generality, we consider only traffic forwarded on one of the two rings, and assume fluid arrivals and services in the idealized reference model, with all rates in the discussion below referring to instantaneous fluid rates. We refer to a flow as all uni-directional traffic between a certain ingress and egress pair, and we denote such traffic between ring ingress node i and ring egress node j as flow (i,j) as illustrated in FIG. 2. Such a flow is typically composed of aggregated micro-flows such as individual TCP sessions, although other flows are possible. To simplify notation, we label a tandem segment of N nodes and N=1 links such that flow (i,j) traverses node n if i≦n≦j, and traverses link n if i≦n≦j.

Consider a set of infinite-demand flows between pairs of a subset of ring nodes, with remaining pairs of nodes having no traffic between them. Denote Rᵢⱼ as the candidate RAIS fair rate for the flow between nodes i and j. The allocated rate is then on link n of the ring is then

$${F}_{n} = {\sum }_{all flows ( i , j ) crossing link n} {R}_{ij} \qquad ( 1 )$$

Let C be the capacity of all links in the ring. Then we can write the following constraints on the matrix of allocated rates R={ij}:

Rᵢⱼ>0, for all flows (i,j) (2)

Fₙ≦C, for all links n (3)

A matrix R satisfying these constraints is said to be feasible. Further, let IA(i) denote the aggregate of all flows originating from ingress node i such that IA(i)=ΣⱼRᵢⱼ.

Given a feasible rate matrix R, we say that link n is a bottleneck link with respect to R for flow (i,j) crossing link n, and denote it by Bₙ(i,j), if two conditions are satisfied. First, Fn=C. For the second condition, we distinguish two cases depending on the number of ingress-aggregated flows on link n. If IA(i) is not the only IA flow at link n, then IA(i)≧IA(i′) for all IA flows IA(i′), and within ingress aggregate IA(i) Rᵢⱼ≧R_{ij′} for all flows (i,j′) crossing link n. If IA(i) is the only ingress-aggregated flow on link n then Rᵢⱼ≧R_{ij′} for all flows (i,j′) crossing link n.

Definition 1: A matrix of rates R is said to be RIAS fair if it is feasible and if for each flow (i, j), Rᵢⱼ cannot be increased while maintaining feasibility without decreasing R_{′j′} for some flow (i′j′) for which

R_{i′j′}≦Rᵢⱼ, when i=i′ (4)

IA(i′)_{atB}_{ₙ}_{(i, j)}+IA(i′)_{atB}_{_{n′}}^{(i′, j′})≦IA(i′)_{atB}_{ₙ₍}_{i, j})+IA(i′)_{atB}_{ₙ}_{i′, j′)} (5)

when IA(i′),IA(i)>0 at both Bₙ(i,j) and Bn′(i′j′), (n≠n′) and

IA(i′)≦IA(i) otherwise. (6)

We distinguish three cases in Definition 1. First, in Equation (4) since flows (i,j) and (i′,j′) have the same ingress node, the inequality ensures fairness among an IA flow's sub-flows to different egress nodes. Second, in Equation (5), flows (i,j) and (i′,j′) have different ingress nodes and different bottleneck links, but Bₙ(i,j) and Bₙ′(i′,j′) are traversed by both ingress aggregates. The inequality ensures that the total rate of IA(i) at Bₙ(i,j) and Bₙ′(i′,j′) does not exceed the total rate of IA(i′) at Bₙ(i,j) and Bₙ′(i′,j′). Finally, in the third case, flows (i,j) and (i′,j′) have different ingress nodes and IA(i) and IA(i′) are both traversing only one or none of Bₙ(i,j) and Bₙ′(i′,j′). Thus, the inequality in Equation (6) ensures fairness among different IA flows.

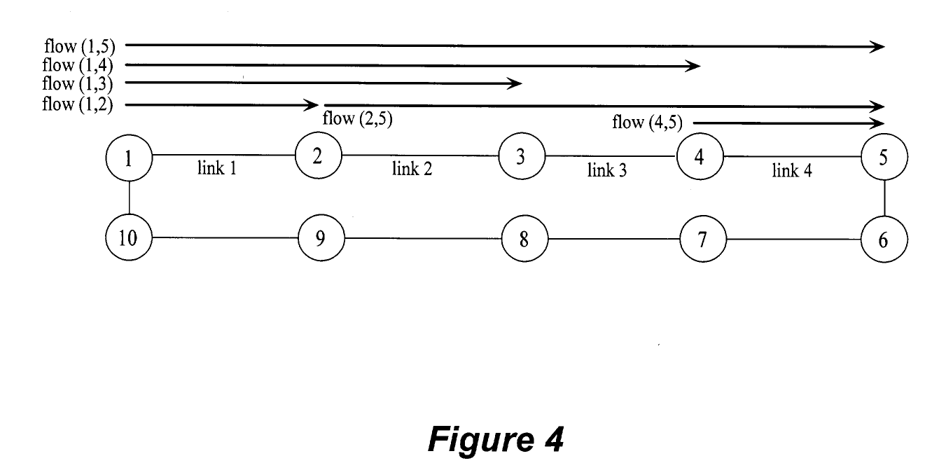

FIG. 4 illustrates the above definition. Assuming that capacity is normalized and all demands are infinite, the RIAS fair shares are as follows: R₁₃=R₁₄=R₁₅=0.2, and R₁₂=R₂₅=R₄₅=0.4. If we consider flow (1,2), its rate cannot be increased while maintaining feasibility without decreasing the rates of flow (1,3), (1,4), or (1,5), where R₁₂≧R₁₃, R₁₄, R₁₅, thus violating Equation (4). If we consider flow (2,5) (with bottleneck link B₄(2,5)), then to increase its rate would require decreasing the rate of flow (1,5) (with bottleneck link B₂(1,5)), where the summation of rates of IA(1) at B₄(2,5)) and B₂(1,5)) is equal to the summation of rates of IA(2) at B₄(2,5)) and B₂(1,5)). Thus, the increase of flow (2,5)'s rate would violate Equation (5). Finally, consider flow (4,5). Its rate cannot be increased while maintaining feasibility without decreasing the rate of flow (1,5) or (2,5), and thereby violating Equation (6).

Proposition 1: A feasible rate matrix R is RIAS-fair if and only if each flow (i,j) has a bottleneck link with respect to R.

Proof: Suppose that R is RIAS-fair, and to prove the proposition by contradiction, assume that there exists a flow (i,j) with no bottleneck link. Then, for each link n crossed by flow (i,j) for which Fₙ=C, there exists some flow (i′j′)≠(i,j) such that one of Equations (4), (5) and (6) is violated (which one depends on the relationship between flows (i′,j′) and (i,j)). Here, we present the proof for the case that Equation (6) is violated or more precisely when IA(i′)>IA(i). The proof is similar for the other two cases. Now, we can write

$${δ}_{n} = \{ \begin{matrix}C - {F}_{n} , & if {F}_{n} < C \\ IA ( {i}^{′} ) - IA ( i ) , & if {F}_{n} = C\end{matrix} \qquad ( 7 )$$

where δₙ is positive. Therefore, by increasing the rate of flow (i,j) ε≦min{δₙ: link n crossed by flow (i,j} while decreasing by the same amount the rate of the flow from IA(i′) on links where Fₙ=C, we maintain feasibility without decreasing the rate of any flow IA(i′) with IA(i′)≦IA(i). This contradicts Definition 1.

For the second part of the proof, assume that each flow has a bottleneck with respect to R. To increase the rate of flow (i,j) at its bottleneck link while maintaining feasibility, we must decrease the rate of at least one flow from IA(i′) (by definition we have Fₙ=C at the bottleneck link). Furthermore, from the definition of bottleneck link, we also have that IA(i′)≦IA(i). Thus, rate matrix R satisfies the requirement for RIAS fairness.

We make three observations about this definition. First, observe that on each link, each ingress node's traffic will obtain no less than bandwidth C/N if its demanded bandwidth is at least C/N. Note, if the tandem segment has N nodes, the ring topology has 2N nodes: if flows use shortest-hop-count paths, each link will be shared by at most half of the total number of nodes on the ring. Secondly, note that these minimum bandwidth guarantees can be weighted to provide different bandwidths to different ingress nodes. Finally, we note that RIAS fairness differs from flow max-min fairness in that RIAS simultaneously considers traffic at two granularities: ingress aggregates and flows. Consequently, as discussed and illustrated below, RIAS bandwidth allocations are quite different that flow max-min fairness as well as proportional fairness.

B. Discussion and Comparison with Alternate Fairness Models

Here, we illustrate RIAS fairness in simple topologies and justify it in comparison with alternate definitions of fairness.

Consider the classical “parking lot” topology of FIG. 5. In this example, we have 5 nodes and 4 links, and all flows sending to the right-most node numbered 5. If node 5 is a gateway to a core or hub node, and nodes 1-4 connect access networks, then achieving equal or weighted bandwidth shares to the core is critical for packet rings. Suppose that the four flows have infinite demand so that the RIAS fair rates are ¼ as defined above.

In contrast, a proportional fair allocation scales bandwidth allocations according to the total resources consumed. In particular, since flow (1,5) traverses four links whereas flow (4,5) traverses only one, the former flow is allocated a proportionally lesser share of bandwidth. For proportional fairness, the fair rates are given by R₁₅=.12, R₂₅=.16, R₃₅=.24, and R₄₅=.48. While proportional fairness has an important role in the Internet and for TCP flow control, in this context it conflicts with our design objective of providing a minimum bandwidth between any two nodes (including gateways), independent of their spatial location.

Second, consider the Parallel Parking Lot topology of FIG. 2, which contains a single additional flow between nodes 1 and 2. In this case, RIAS fairness allows flow (1,2) to claim all excess bandwidth on link 1 such that R₁₂=¾ and all other rates remain ¼. Observe that although RIAS fairness provides fair shares using ingress aggregated demand, actual rates are determined on a flow granularity. That is, flows (1,2) and (1,5) have different RIAS fair rates despite having the same ingress node. As described in Section II, allocations having only a single ingress rate for all destinations suffer from under-utilization in scenarios such as in FIG. 2.

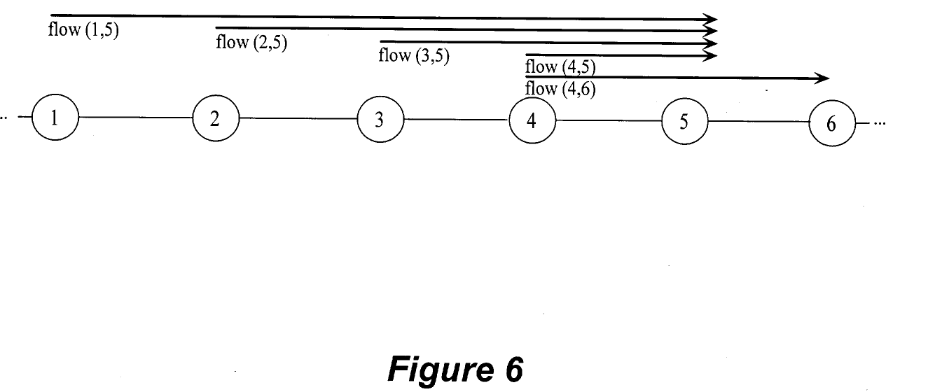

Finally, consider the “two exit” topology of FIG. 6. Here, we consider an additional node 6 and an additional flow (4,6) so that ingress node 4 now has two flows on bottleneck link 4. In this case, the RIAS fair rates of flows (1,5), (2,5), and (3,5) are still R₁₅=R₂₅=R₃₅=¼, whereas ingress node 4 divides its IA fair rate of ¼ among its two flows such that R₄₅=R₄₆=⅛. This allocation contrasts to a traditional “global” flow-based max-min fair allocation in which all 5 flows would receive rate ⅕, an allocation that is not desirable in packet rings. Extrapolating the example to add more nodes 7, 8, 9, . . . and adding flows (4,7), (4,8), (4,9), . . . , it is clear that flow-based max-min fairness rewards an ingress node (node 4) for spreading out its traffic across many egress nodes, and penalizes nodes (1, 2, and 3) that have all traffic between a single ingress-egress pair. RIAS fairness in contrast, ensures that each ingress node's traffic receives an equal bandwidth share on each link for which it demands traffic.

IV. PERFORMANCE LIMITS OF RPR

In this section, we present a number of important performance limits of the RPR fairness algorithm in the context of the RIAS objective.

A. Permanent Oscillation with Unbalanced Constant-Rate Traffic Inputs

The RPR fairness algorithm suffers from severe and permanent oscillations for scenarios with unbalanced traffic. There are multiple adverse effects of such oscillations, including throughput degradation and increased delay jitter. The key issue is that the congestion signals add_rate for Aggressive Mode and (C/number of active stations) for Conservative Mode do not accurately reflect the congestion status or true fair rate and hence nodes oscillate in search of the correct fair rates.

A.1Aggressive Mode

Recall that without congestion, rates are increased until congestion occurs. In AM, once congestion occurs, the input rates of all nodes contributing traffic to the congested link are set to the minimum input rate. However, this minimum input rate is not necessarily the RIAS fair rate. Consequently, nodes over-throttle their traffic to rates below the RIAS rate. Subsequently, congestion will clear and nodes will ramp up their rates. Under certain conditions of unbalanced traffic, this oscillation cycle will continue permanently and lead to throughput degradation. Let rᵢⱼ denote the demanded rate of flow (i,j). The AM oscillation condition is given by the following.

Proposition 2. For a given RIAS rate matrix R, demanded rates rand congested link j, permanent oscillations will occur in RPR-AM if there is a flow (n,i) crossing link j such that following two conditions are satisfied:

$${r}_{osc} = {min}_{n < k \leq j , l > j} min ( {r}_{kl} , {R}_{kl} ) < {R}_{ni}$$

$${r}_{osc} < {r}_{ni}$$

Moreover, for small buffers and zero propagation delay, the range of oscillations will be from r_{osc} to min(rₙᵢ,Rₙᵢ).

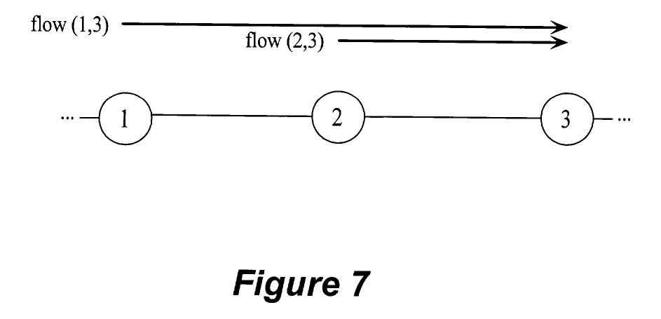

For example, consider Aggressive Mode with two flows such that flow (1,3) originating upstream has demand for the full link capacity C, and flow (2,3) originating downstream has a low rate which we denote by ε (cf. FIG. 7). Here, considering flow (1,3), we have j=2, r_{osc}=ε and R₁₃=C−ε, where R₁₃>r_{osc} and r₁₃>r_{osc}. Hence the demands are constant rate and unbalanced.

Since the aggregate traffic arrival rate downstream is C+ε, the downstream link will become congested. Thus, a congestion message will arrive upstream containing the transmission rate of the downstream flow, in this case ε. Consequently, the upstream node must throttle its flow from rate C to rate ε. At this point, the rate on the downstream link is 2ε so that congestion clears. Subsequently, the upstream flow will increase its rate back to C−ε upon receiving null congestion messages. Repeating the cycle, the upstream flow's rate will permanently oscillate between C−ε and the low rate of the downstream flow ε.

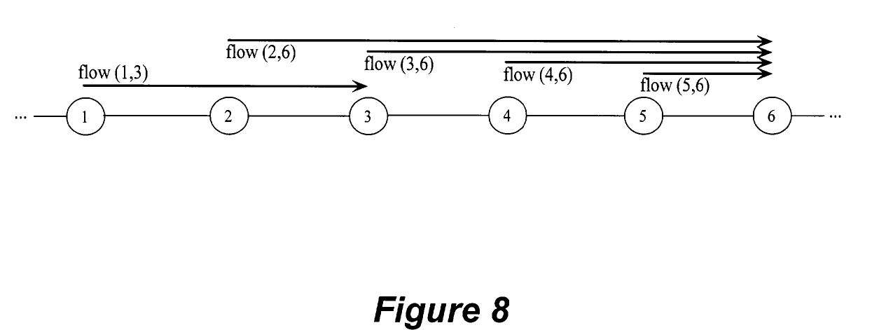

Observe from Proposition 2 that oscillations also occur with balanced input rates but unbalanced RIAS rates. An example of such a scenario is depicted in FIG. 8 in which each flow has identical demand C. In this case, flow (1,3) will permanently oscillate between rates ¼ and ¾ since R₁₃=¾, r_{osc}¼ and r₁₃=∞, thus r_{osc}<R₁₃ and r₁₃>r_{osc}.

A.2 Conservative Mode

Unbalanced traffic is also problematic for Conservative Mode. With CM, the advertised rate is determined by the number of active flows when a node first becomes congested for two consecutive aging_intervals. If a flow has even a single packet transmitted during the last aging_interval, it is considered active. Consequently, permanent oscillations occur according to the following condition.

Proposition 3: For a given RIAS rate matrix R, demanded rates r, and congested link j, let nₐ denote the number of active flows on link j, and n_{g} denote the number of flows crossing link j that have both demand and RIAS fair rate greater than C/nₐ. Ignoring low pass filtering and propagation delay, permanent oscillations will occur in RPR-CM if there is a flow (n,i) crossing link j such that the following two conditions are satisfied

$$\begin{matrix}min ( {R}_{ni} , {r}_{ni} ) < \frac{C}{{n}_{a}} \\ {n}_{g} \frac{C}{{n}_{a}} {S}_{s} < low\_threshold \\ where \\ {S}_{s} = {\sum }_{k \leq j , l > j , min ( {R}_{kl} , {r}_{kl} ) < \frac{C}{{n}_{a}}} min ( {R}_{kl} , {r}_{kl} )\end{matrix}$$

Moreover, the lower limit of the oscillation range is C/nₐ. The upper limit is less than low_threshold and depends on the offered load of the n_{g} flows.

For example, consider a two-flow scenario similar to that above except with the upstream flow (1,3) having demand ε and the downstream flow having demand C. Since flow (1,3) with rate ε is considered active, the feedback rate of CM at link 2 is C/2, and flow (2,3) will throttle to this rate in the next aging_interval. At this point, the arrival rate at node 2 is C/2+ε, less than the low_threshold, so that congestion clears, and flow (2,3) increases its rate periodically until the downstream link is congested again. Repeating the cycle, the rate of the downstream flow will permanently oscillate between C/2 and low_threshold−ε.

B. Throughput Loss

As a consequence of permanent oscillations, RPR-AM and RPR-CM suffer from throughput degradation and are not able to fully exploit spatial reuse.

B.1Aggressive Mode

Here, we derive an expression for throughput loss due to oscillations. For simplicity and without loss of generality, we consider two-flow cases as depicted in FIG. 7. We ignore low pass filtering and first characterize the rate increase part of a cycle, denoting the minimum and maximum rate by rₘᵢₙ and rₘₐₓ, respectively. Further, let τa denote the aging_interval, τp the propagation delay, Qₖ the value of the second node's queue size at the end of the k^{th} aging_interval, R the RIAS fair rates, and B, the buffer threshold. Finally, denote rₖ as the upstream rate after the k^{th} aging_interval and let the cycle begin with r₀=rₘᵢₙ. The rate increase portion of the cycle is then characterized by the following.

$$\begin{matrix}{r}_{0} = {r}_{min} \\ {r}_{k} = {r}_{k - 1} + \frac{C - {r}_{k - 1}}{rampcoef} \\ {r}_{K} = \{ {r}_{k} \vert {r}_{k} \leq {r}_{max} and {r}_{k + 1} > {r}_{max} \} \\ {r}_{L} = \{ {r}_{k} \vert {Q}_{k - 1} = 0 and {Q}_{k} > 0 \} \\ {r}_{M} = \{ {r}_{k} \vert {τ}_{a} {{\sum }_{i = L + 1}}^{i - M - 1} ( {r}_{i} - R ) < {B}_{t} and {τ}_{a} {{\sum }_{i = L + 1}}^{i = M} ( {r}_{i} - R ) \geq Bt \\ {r}_{N} = \{ {r}_{k} \vert ( N - M ) {τ}_{a} \geq {τ}_{p} and ( N - M - 1 ) {τ}_{a} < {τ}_{p} \}\end{matrix}$$

Note that r_{N+1}=rₘᵢₙ such that the cycle repeats according to the definition of RPR-AM. From the expressions above, observe that during one oscillation cycle, the K^{th} aging_interval is the last interval for which the rate is less than the RIAS fair rate, the L^{th} aging_interval is the interval in which the second node's queue starts filling up, the M^{th} aging_interval is the interval in which the second node's queue reaches its threshold, and finally, the N^{th} aging_interval is the interval in which the rate reaches its maximum value rₘₐₓ.

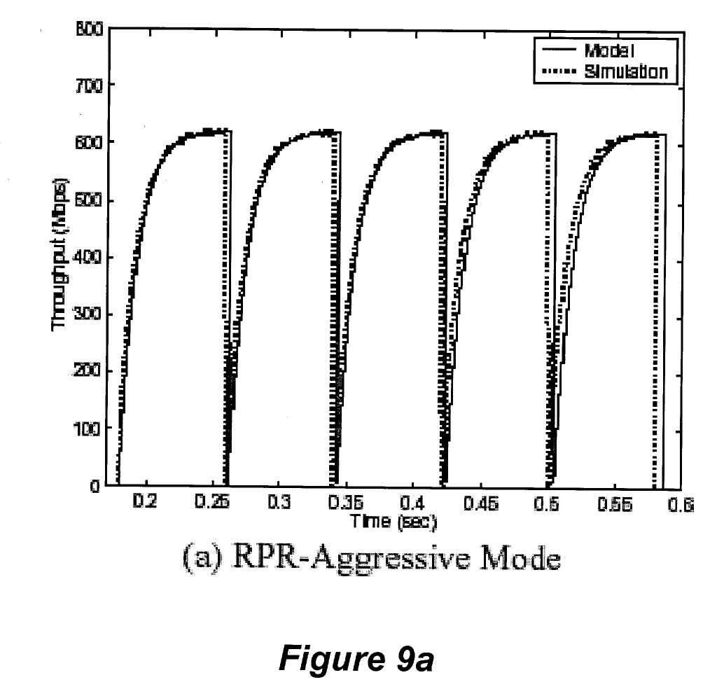

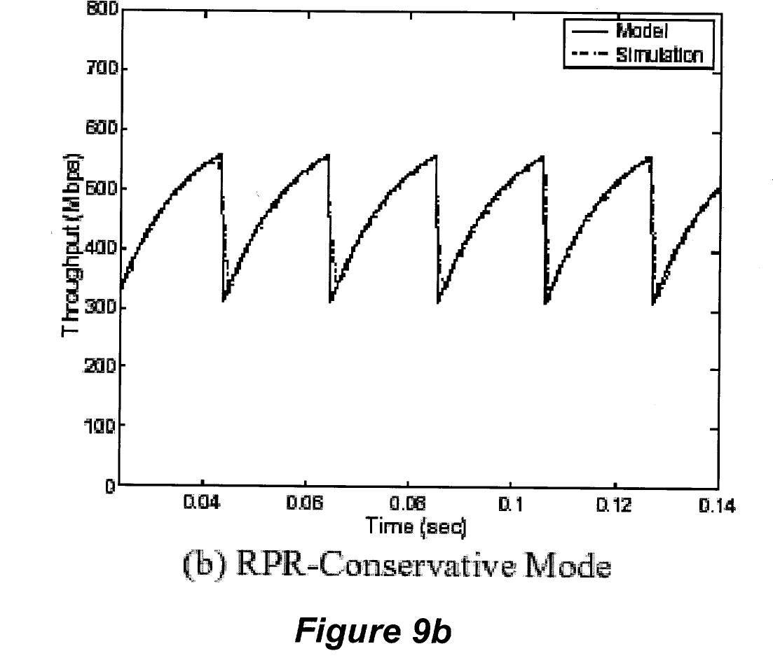

FIG. 9(a) depicts the oscillations obtained according to the above model as well as those obtained by simulation for a scenario in which upstream flow (1,3) has demand 622 Mbps and downstream flow (2,3) has demand. As described in Section VII, the simulator provides a complete implementation of the RPR fairness algorithms. Observe that even ignoring low pass filtering, the model matches RPR-AM's oscillation cycle very accurately.

From this characterization of an oscillation cycle, we can compute the throughput loss for the flow oscillating between rates r₀ and r_{N} as follows.

$${ρ}_{loss} = \frac{1}{N} {\sum }_{K = 0}^{k = N} ( R - {r}_{k} ) \qquad ( 8 )$$

where R is the RIAS fair rate.

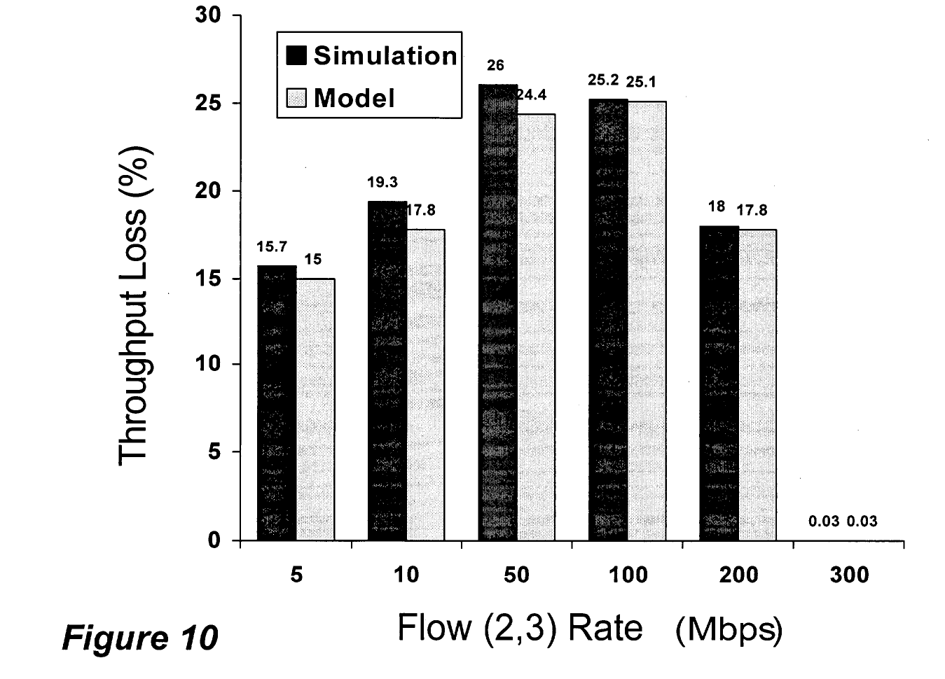

FIG. 10 depicts throughput loss vs. the downstream flow (2,3) rate for the two-flow scenario for the analytical model of Equation (8) and simulations. Observe that the throughput loss can be as high as 26% depending on the rate of the downstream flow. Moreover, the analytical model is quite accurate and matches the simulation results within 2%. Finally, observe that the throughput loss is non-monotonic. Namely, for downstream input rates that are very small, the upstream rate controller value drops dramatically but quickly recovers, as there is little congestion downstream. For cases with higher rate downstream flows, the range of oscillation for the upstream rate controller is smaller, but the recovery to full rate is slower due to increased congestion. Finally, if the offered downstream rate is the fair rate (311 Mbps here), the system is “balanced” and no throughput degradation occurs.

B.2 Conservative Mode

Throughput loss for Conservative Mode has two origins. First, as described in Section II, the utilization in CM is purposely restricted to less than high_threshold, typically 95%. Second, similar to AM, permanent oscillations occur with CM under unbalanced traffic resulting in throughput degradation and partial spatial reuse. We derive an expression to characterize CM throughput degradation in a two-flow scenario as above. Let rₖ denote the sending rate of flow (2,3) in the k^{th} aging_interval as specified by the RPR-CM algorithm. Moreover, let the oscillation cycle begin with r₀=rₘᵢₙ=C/nₐ, where nₐ is the number of active flows. The following illustrates the rate-oscillating behavior of flow (2,3) in a cycle.

$$\begin{matrix}{r}_{0} = \frac{C}{{n}_{a}} \\ {r}_{k} = {r}_{k - 1} + \frac{C - {r}_{k - 1}}{{rampcoef}^{′}} \\ if lpf ( {r}_{k - 1} + {r}_{13} ) < low\_threshold \\ {r}_{N} = \{ {r}_{k} \vert lpf ( {r}_{k} - 1 + {r}_{13} ) \geq low\_threshold \\ and lpf ( {r}_{k - 1} + {r}_{13} ) < low\_threshold \} \end{matrix}$$

where r₁₃ is the sending and demanded rate of flow (1,3). The function lpf( ) is the low pass filtered total transmit rate of flow (1,3) and flow (2,3) at link 2. When the lpf( ) rate is less than low_threshold at the k^{th} aging_interval, link 2 is not congested and flow (2,3) increases its rate with a constant parameter rampcoef. At the N^{th} aging_interval, the lpf( ) rate reaches low_threshold, such that link 2 becomes congested again, and consequently, flow (2,3) immediately sets its rate to rₘᵢₙ. Thus, the maximum sending rate of flow (2,3) in steady state is r_{N}.

Notice that link 2 will not be continuously congested after the N^{th} aging_interval because flow (2,3) originates at link 2 such that there is no delay for flow (2,3) to set its rate to rₘᵢₙ. Thus, a new cycle starts right after the (N+1)^{th} aging_interval.

FIG. 9(b) depicts the oscillations obtained from analysis and simulations for an example with the upstream flow (1,3) having input rate 5 Mbps and the downstream flow (2,3) having input rate 600 Mbps, and indicates an excellent match despite the model simplifications.

Finally, to analyze the throughput loss of RPR-CM, we consider parking lot scenarios with N unbalanced flows originating from N nodes sending to a common destination. For a reasonable comparison, the sum of the demanding rate of all flows is 605 Mbps, which is less then the link capacity. The 1^{st} to (N−1)^{th} flows demand 5 Mbps, and the N^{th} flow that is closest to the common destination demands 605-5(N−1) Mbps. In simulations, the packet size of the N^{th} flow is 1 KB, and that of the others is 100 B to ensure that the (N−1) flows are active in each aging_interval.

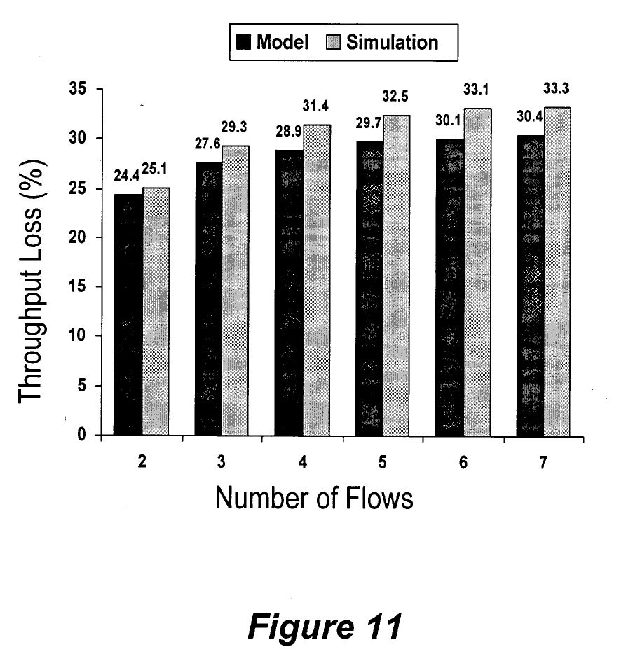

FIG. 11 depicts throughput loss obtained from simulations as well as the above model using Equation (8). We find that the throughput loss with RPR-CM can be up to 30%, although the sum of the offered load is less than the link capacity. Finally, observe that the analytical model is again quite accurate and matches the simulation results within 3%

A. Convergence

Finally, the RPR algorithms suffer from slow convergence times. In particular, to mitigate oscillations even for constant rate traffic inputs as in the example above, all measurements are low pass filtered. However, such filtering, when combined with the coarse feedback information, has the effect of delaying convergence (for scenarios where convergence does occur). We explore this effect using simulations in Section VII.

V. DISTRIBUTED VIRTUAL TIME SCHEDULING IN RINGS (DVSR)

In this section, we devise a distributed algorithm to dynamically realize the bandwidth allocations in the RIAS reference model. Our technique is to have nodes construct a proxy of virtual time at the Ingress Aggregated flow granularity. This proxy is a lower bound on virtual time temporally aggregated over time and spatially aggregated over traffic flows sharing the same ingress point (IA flows). It is based on simple computations of measured IA byte counters such that we compute the local bandwidth shares as if the node was performing IA-granularity fair queuing, when in fact, the node is performing FIFO queuing. By distributing this information to other nodes on the ring, all nodes can remotely compute their fair rates at downstream nodes, and rate control their per-destination station traffic to the RIAS fair rates.

We first describe the algorithm in an idealized setting, initially considering virtual time as computed in a generalized processor sharing (“GPS”) fluid system with an IA flow granularity. We then progressively remove the impractical assumptions of the idealized setting, leading to the network-processor implementation described in Section VIII.

We denote rᵢⱼ(t) as the offered input rate (demanded rate) at time t from ring ingress node i to ring egress node j. Moreover let $\rhoᵢⱼ(t) denote the rate of the per-destination ingress shaper for this same flow. Finally, let the operation max_minᵢ(C,x₁,x₂, . . . ,xₙ) return the max-min fair share for the user with index i of a single resource with capacity C, and demands x₁, x₂, . . . , xₙ. The operational definition of max-min fairness for a single resource is a special case of the multi-link operational definition, and is presented in Table 1 in the context of DVSR.

A. Distributed Fair Bandwidth Allocation

The distributed nature of the ring bandwidth allocation problem yields three fundamental issues that must be addressed in algorithm design. First, resources must be remotely controlled in that an upstream node must throttle its traffic according to congestion at a downstream node. Second, the algorithm must contend with temporally aggregated and delayed control information in that nodes are only periodically informed about remote conditions, and the received information must be a temporally aggregated summary of conditions since the previous control message. Finally, there are multiple resources to control with complex interactions among multi-hop flows. We next consider each issue independently.

A.1Remote Fair Queuing

The first concept of DVSR is control of upstream rate-controllers via use of ingress-aggregated virtual time as a congestion message received from downstream nodes. For a single node, this can be conceptually viewed as remotely transmitting packets at the rate that they would be serviced in a GPS system, where GPS determines packet service order according to a granularity of packets' ingress nodes only (as opposed to ingress and egress nodes, micro-flows, etc.).

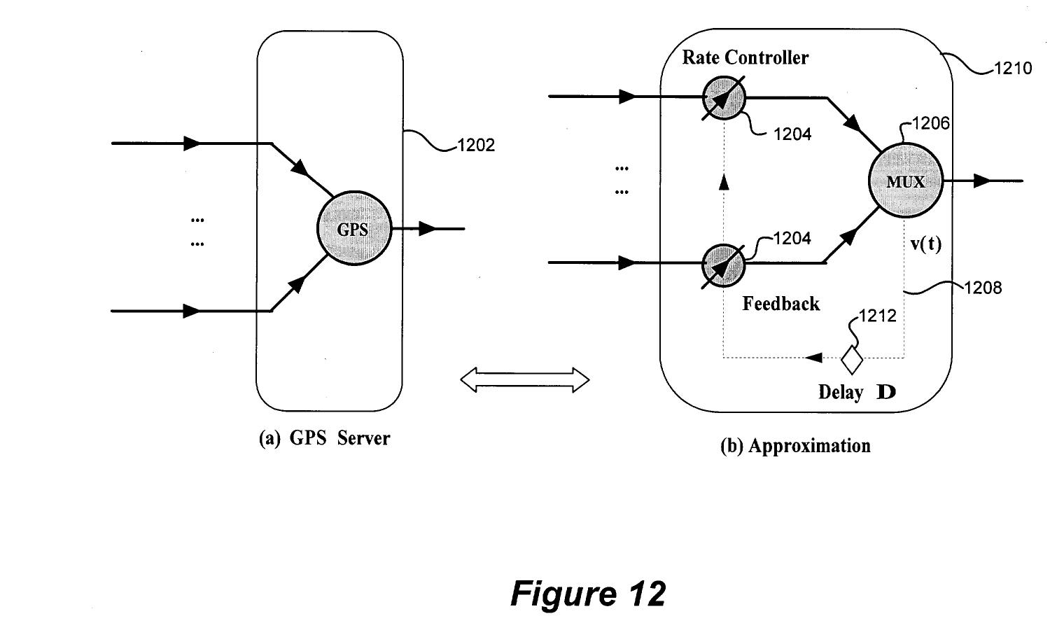

FIG. 12 illustrates remote bandwidth control for a single resource. In this case, RIAS fairness is identical to flow max-min fairness so that GPS server 1202 can serve as the ideal reference scheduler (see FIG. 12(a)). Conceptually, consider that the depicted multiplexer 1206 (labeled “MUX” in FIG. 12(b)) computes virtual time as if it is performing idealized GPS, i.e., the rate of change of virtual time is inversely proportional to the (weighted) number of backlogged flows. The system 1210 on the right approximates the service of the (left) GPS system 1202 via adaptive rate control using virtual time information. In particular, consider for the moment that the rate controllers 1204 receive continuous feedback of the multiplexer's 1206 virtual time calculation 1208 and that the delay 1212 in receipt of this information is Delta=0. The objective is then to set the rate controller values to the flows' service rates in the reference system. In the idealized setting, this can be achieved by the observation that the evolution of virtual time reveals the fair rates. In this case, considering a link capacity C=1 and denoting virtual time as v(t), the rate for flow i and hence the correct rate controller value is simply given by

ρi(t)=min(1, dv(t)/dt)

when vᵢ(t)>0 and 1 otherwise. Note that GPS has fluid service such that all flows are served at identical (or weighted) rates whenever they are backlogged.

For example, consider the four-flow parking lot example of Section III. Suppose that the system is initially idle so that ρi(0)=1, and that immediately after time 0, flows begin transmitting at infinite rate (i.e., they become infinitely backlogged flows). As soon as the multiplexer depicted in FIG. 12(b) becomes backlogged, v(t) has slope ¼. With this value instantly fed back, all rate controllers are immediately set to ρi=¼ and flows are serviced at their fair rate.

Suppose, at some later time, the 4th flow shuts off so that the fair rates are now ⅓. As the 4th flow would no longer have packets (fluid) in the multiplexer, v(t) will now have slope ⅓ and the rate limiters are set to ⅓. Thus, by monitoring virtual time, flows can increase their rates to reclaim unused bandwidth and decrease it as other flows increase their demand. Note that with 4 flows, the rate controllers will never be set to rates below ¼, the minimum fair rate.

Finally, notice that in this ideal fluid system with zero feedback delay, the multiplexer is never more than infinitesimally backlogged, as the moment fluid arrives to the multiplexer, flows are throttled to a rate equal to their GPS service rates. Hence, all buffering and delay is incurred before service by the rate controllers.

A.2 Delayed and Temporally Aggregated Control Information

The second key component of distributed bandwidth allocation in rings is that congestion and fairness information shared among nodes is necessarily delayed and temporally aggregated. That is, in the above discussion we assumed that virtual time is continually fed back to the rate controllers without delay. However, in practice feedback information must be periodically summarized and transmitted in a message to other nodes on the ring. Thus, delayed receipt of summary information is also fundamental to a distributed algorithm.

For the same single resource example of FIG. 12, and for the moment for Δ=0, consider that every T seconds the multiplexer transmits a message summarizing the evolution of virtual time over the previous T seconds. If the multiplexer is continuously backlogged in the interval [t-T,t], then information can be aggregated via a simple time average. If the multiplexer is idle for part of the interval, then additional capacity is available and rate controller values may be further increased accordingly. Moreover, v(t) should not be reset to 0 when the multiplexer goes idle, as we wish to track its increase over the entire window T. Thus, denoting b as the fraction of time during the previous interval T that the multiplexer is busy serving packets, the rate controller value should be

ρi(t)=min(1, (v(t)−v(t−T))/T+(1−b)). (9)

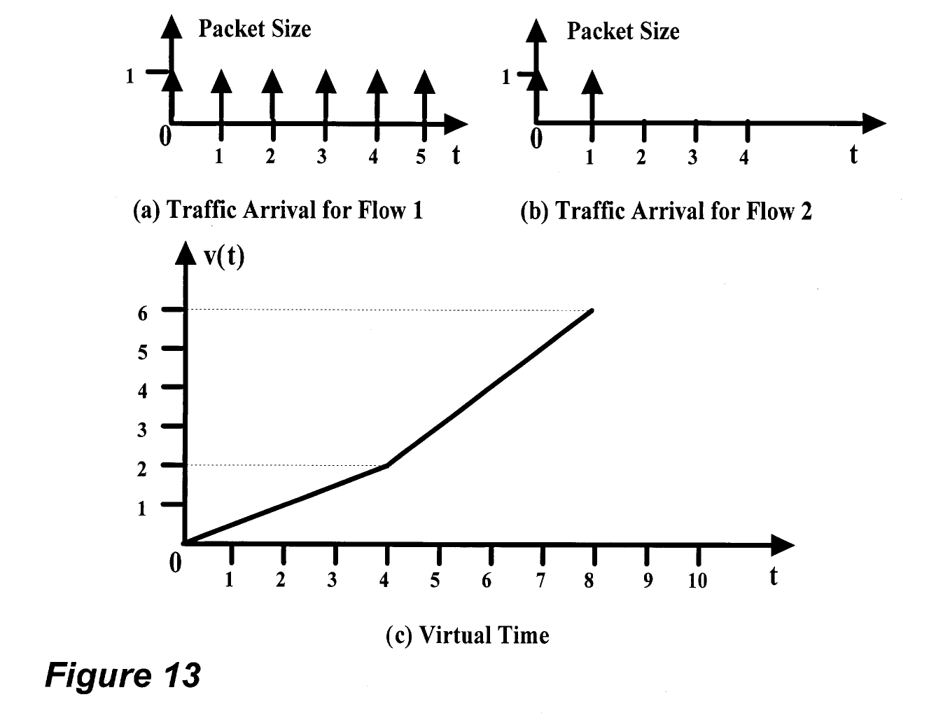

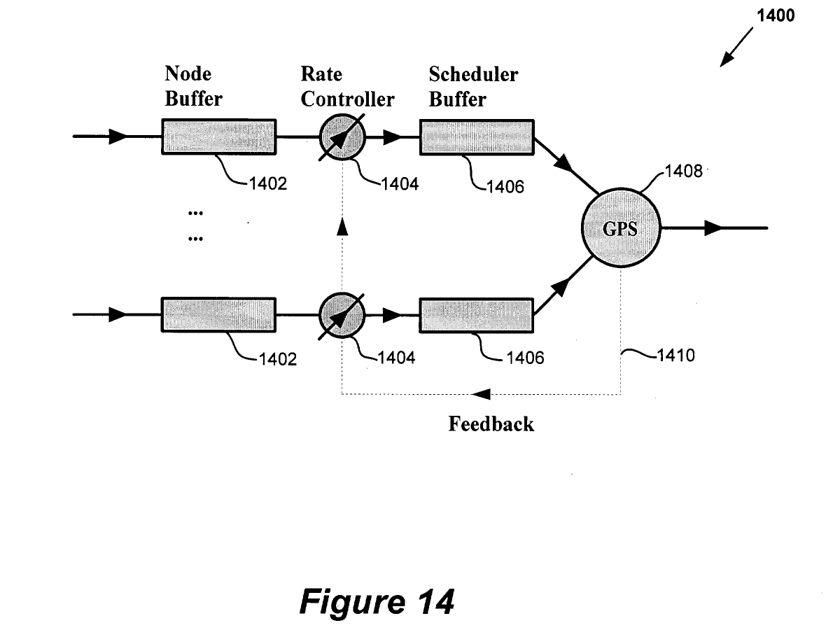

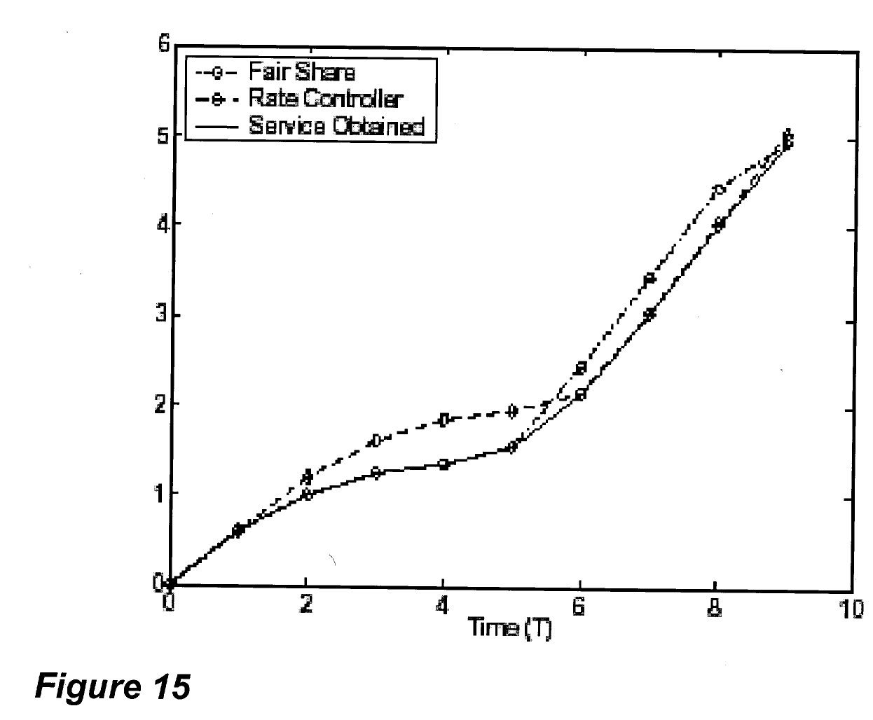

The example depicted in FIG. 13 illustrates this time averaged feedback signal and the need to incorporate b that arises in this case (but not in the above case without time averaged information). Suppose that the link capacity is 1 packet per second and that T=10 packet transmission times. If the traffic demand is such that six packets arrive from flow 1 and two packets from flow 2, then 2 flows are backlogged in the interval [0,4], 1 flow in the interval [4,8], and 0 flows in [8,10]. Thus, since b=0.8 the rate limiter value according to Equation (9) is 0.8. Note that if both flows increase their demand from their respective rates of 0.6 and 0.2 to this maximum rate controller value of 0.8, congestion will occur and the next cycle will have b=1 and fair rates of 0.5.

Finally, consider that the delay to receive information is given by Δ>0. In this case, rate controllers will be set at time t to their average fair rate for the interval [t-T-Δ, t-Δ]. Consequently, due to both delayed and time averaged information, rate controllers necessarily deviate from their ideal values, even in the single resource example. We consider such effects of Δ and T analytically in Section VI and via simulations in Section VII.

A.3 Multi-node RIAS Fairness

There are three components to achieving RIAS fairness encountered in multiple node scenarios. First, an ingress node must compute its minimum fair rate for the links along its flows' paths. Thus, in the parking lot example, node 1 initially receives fair rates 1, 1/2, 1/3, and ¼ from the respective nodes on its path and hence sets its ingress rate to ¼.

Second, if an ingress node has multiple flows with different egress nodes sharing a link, it must sub-allocate its per-link IA fair rate to these flows. For example, in the Two Exit Parking Lot scenario of FIG. 6, node 4 must divide its rate of ¼ at link 4 between flows (4,5) and (4,6) such that each rate is ⅛. (Recall that this allocation, as opposed to all flows receiving rate ⅕, is RIAS fair.) The first and second steps can be combined by setting the rate limiter value to be

$${ρ}_{i , j} ( t ) = min ( 1 , {min}_{i \leq n < j} {ρ}_{i}^{n} \text{/} \vert {ρ}_{i}^{n} \vert \qquad ( 10 )$$

where ρᵢⁿ is the single link fair rate at link n as given by Equation (9) and |ρᵢⁿ| denotes the number of flows at link n with ingress node i. This sub-allocation could also be scaled to the demand using the max_min operator. For simplicity, we consider equal sub-allocation here.

Finally, we observe that in certain cases, the process often requires multiple iterations to converge, even in this still idealized setting, and hence multiple intervals T to realize the RIAS fair rates. The key reason is that nodes cannot express their true “demand” to all other nodes initially, as they may be bottlenecked elsewhere. For example, consider the scenario illustrated in FIG. 8 in which all flows have infinite demand. After an initial window of duration T, flow (2,6) will be throttled to its RIAS fair rate of ¼ on link 5. However, flow (1,3) will initially have its rate throttled to ½ rather than ¾, as there is no way yet for node 1 to know that flow (2,6) is bottlenecked elsewhere. Hence, it will take a second interval T in which the unused capacity at link 2 can be signalled to node 1, after which flow (1,3) will transmit at its RIAS fair rate of ¾.

B. DVSR Protocol

In the discussion above, we presented DVSR's conceptual operation in an idealized setting. Here, we describe the DVSR protocol as implemented in the simulator and testbed. We divide the discussion into four parts: scheduling of station vs. transit packets, computation of the feedback signal (control message), transmission of the feedback signal, and rate limit computation.

B.1 Scheduling of Station vs. Transit Packets

As described in Section II, the high speed of the transit path and requirements for hardware simplicity prohibit per-ingress transit queues and therefore prohibit use of fair queuing or any of its variants, even at the IA granularity. Consequently, we employ first-in first-out scheduling of all offered traffic (station or transit) in both the simulator and implementation.

Recall that the objective of DVSR is to throttle flows to their ring-wide RIAS-fair rate at the ingress point. Once this is achieved and steady state is reached, queues will remain empty and the choice of the scheduler is of little impact. Before convergence (typically less than several ring propagation times in our experiments) the choice of the scheduler impacts the jitter and short-term fairness properties of any fairness algorithm. While a number of variants on FIFO are possible, especially when also considering high priority class A traffic, we leave a detailed study of scheduler design to future work and focus on the fairness algorithm.

B.2 Feedback Signal Computation

As inputs to the algorithm, a node measures the number of arriving bytes from each ingress node, including the station, over a window of duration T. Thus, the measurements used by DVSR are identical to those of RPR. We denote the measurement at this node from ingress node i as lᵢ (omitting the node superscript for simplicity).

First, we observe that the exact value of v(t)−v(t-T) cannot be derived only from byte counters as v(t) exposes shared congestion whereas byte counts do not. For example, consider that two packets from two ingress nodes arrive in a window of duration T. If the packets arrive back-to-back, then v(t) increases by 1 over an interval of 2 packet transmission times. On the other hand, if the packets arrive separately so that their service does not overlap, then v(t) increases from 0 to 1 twice. Thus, the total increase in the former case is 1 and in the latter case is 2, with both cases having a total backlogging interval of 2 packet transmission times.

However, a lower bound to v(t)−v(t-T) can be computed by observing that the minimum increase in v(t) occurs if all packets arrive at the beginning of the interval. This minimum increase will then provide a lower bound to the true virtual time, and is used in calculation of the control message's rate. We denote F as v(t)−v(t−T)/T+(1−b) at a particular node. Moreover, consider that the byte counts from each ingress node are ordered such that l1≦l2≦ . . . ≦k for k flows transmitting any traffic during the interval. Then F is computed every T seconds as given by the pseudo code of Table I. For simplicity of explanation, we consider the link capacity C to be in units bytes/sec and consider all nodes to have equal weight.

TABLE I
IA-Fair Rate computation at Intervals T

if (b < 1) { F = 1ₖ/CT + (1 − b) }
else {

i = 1
F = 1/k
Count = k
Rcapacity = 1
while ((1ᵢ/CT < F) AND (1ₖ/CT >= F)) {

Count-
Rcapacity −= 1ᵢ/CT
F = Rcapacity/Count
1ᵢ = 1ᵢ₊₁

}

}

Note that when b<1 (the link is not always busy over the previous interval), the value of F is simply the largest ingress-aggregated flow transmission rate lₖ/CT plus the unused capacity. When b=1, the pseudo-code computes the max-min fair allocation for the largest ingress-aggregated flow so that F is given by F=max_minₖ(l, l₁/CT, l₂/CT, . . . lₖ/CT).

Implementation of the algorithm has several aspects not yet described. First, b is easily computed by dividing the number of bytes transmitted by CT the maximum number of bytes that could be serviced in T. Second, ordering the byte counters such that l1≦l2≦ . . . ≦1ₖ requires a sort with complexity O(k log k). For a 64 node ring with shortest path routing, the maximum value of k is 32 such that k log k is 160. Finally, the main while loop in Table I has at most k iterations. As DVSR's computational complexity does not increase with link capacity, and typical values of T are 0.1 to 5 msec, the algorithm is easily performed in real time in our implementation's 200 MHz network processor.

B.3 Feedback Signal Transmission

We next address transmission of the feedback signal. In our implementation, we construct a single N-byte control message containing each node's most recently computed value of F such that the message contains F¹, F², . . . , F^{N} for the N-node ring. Upon receiving a control message, node n replaces the n^{th} byte with its most recently computed value of Fⁿ as determined according to Table I.

An alternate messaging approach more similar to RPR is to have each node periodically transmit messages with a single value Fⁿ vs. having all values in a circulating message. Our adopted approach results in fewer control message packet transmissions.

B.4 Rate Limit Computation

The final step is for nodes to determine their rate controller values given their local measurements and current values of Fⁱ. This is achieved as described above in which each (ingress) node sub-allocates its per-link fair rates to the flows with different egress nodes.

C. Discussion

We make several observations about the DVSR algorithm. First, note that if there are N nodes forwarding traffic through a particular transit node, rate controllers will never be set to rates below 1/N, the minimum fair rate. Thus, even if all bandwidth is temporarily reclaimed by other nodes, each node can immediately transmit at this minimum rate; after receiving the next control message, upstream nodes will throttle their rates to achieve fairness at timescales greater than T; until T, packets are serviced in FIFO order.

Next, observe that by weighting ingress nodes, any set of minimum rates can be achieved, if the sum of such minimum rates is less than the link capacity.

Third, we note that the DVSR protocol is a distributed mechanism to compute the RIAS fair rates. In particular, to calculate the RIAS fair rates, we first estimate the local IA-fair rates using local byte counts. Once nodes receive their locally fair rates, they adapt their rate limiter values converging to the RIAS rates.

Finally, we observe that unlike the RPR fairness algorithm, DVSR does not low pass filter control signal values at transit nodes nor rate limiter values at stations. One important reason is that the system has a natural averaging interval built in via periodic transmission of control signals. By selecting a control signal that conveys a bound on the time-averaged increase in IA virtual time as opposed to the station transit rate, no further damping is required.

VI. ANALYSIS OF DVSR FAIRNESS

There are many factors of a realistic system that will result in deviations between DVSR service rates and ideal RIAS fair rates. Here, we isolate the issue of temporal information aggregation and develop a simple theoretical model to study how T impacts system fairness. The technique can easily be extended to study the impact of propagation delay, an issue we omit for brevity.

A. Scenario

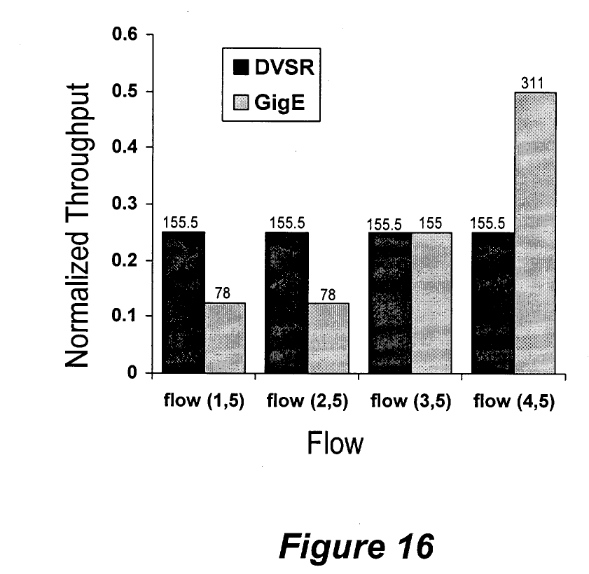

We consider a simplified but illustrative scenario with remote fair queuing and temporally aggregated feedback as in FIG. 12. We further assume that the multiplexer is an ideal fluid GPS server, and that the propagation delay is ?=0. We consider two flows i and j that have infinite demand and are continuously backlogged. For all other flows, we consider the worst case traffic pattern that maximizes the service discrepancy between flows i and j. Thus, FIG. 14 depicts the analysis scenario 1400 and highlights the relative roles of the node buffer 1402 queuing station traffic at rate controllers 1404 vs. the scheduler buffer 1406 queuing traffic at transit nodes.

We say that a flow node-backlogged if the buffer at its ingress node's rate controller is non-empty and that a flow is scheduler-backlogged if the (transit/station) scheduler buffer is non-empty. Moreover, whenever the available service rate at the GPS multiplexer is larger than the rate limiter value in DVSR, the flow is referred to as over-throttled. Likewise, if the available GPS service rate is smaller than the rate limiter value in DVSR, the flow is under-throttled. Note that as we consider flows with infinite demand, flows are always node-backlogged such that traffic enters the scheduler buffer at the rate controllers' rates. Observe that the scheduler buffer occupancy increases in under-throttled situation. However, while an over-throttled situation may result in a flow being under-served, it may also be over-served if the flow has traffic queued previously.

B. Fairness Bound

To characterize the deviation of DVSR from the reference model for the above scenario, we first derive an upper bound on the total amounts of over- and under-throttled traffic as a function of the averaging interval T.

For notational simplicity, we consider fixed size packets such that time is slotted, and denote v(k) as the virtual time at time kT. Moreover, let b(k) denote the total non-idle time in the interval [kT, (k+1)T] and denote the number of flows (representing ingress nodes) by N. The bound for under-throttled traffic is derived as follows.

Lemma 1: A node-backlogged flow in DVSR can be under throttled by at most (1/−1/N)CT.

Proof: For a node-backlogged flow i, an under-throttled situation occurs when the fair rate decreases, since the flow will temporarily be throttled using the previous higher rate. In such a case, the average slope of v(t) decreases between times kT and (k+1)T. For a system with N flows, the worst case of under-throttling occurs when the slope repeatedly decreases for N consecutive periods of duration T. Otherwise, if the fair rate increases, flow i will be over throttled, and the occupancy of the scheduler buffer is decreasing during that period. Thus, assuming flow i enters the system at time 0, and denoting Uᵢ(N) as the total amount of under-throttled traffic for flow i by time N, we have

$$\begin{matrix}{U}_{i} ( N ) = {\sum }_{k = 0}^{N - 1} ( ( v ( k ) - v ( k - 1 ) ) - ( v ( k + 1 ) - v ( k ) ) ) \\ = ( v ( 0 ) - v ( - 1 ) ) - 9 v ( N ) - v ( N - 1 ) ) \\ \leq ( C - \frac{1}{N} C ) T\end{matrix}$$

since v(k+1)−v(k) is the total service obtained during slot kT for flow i as well as the total throttled traffic for slot (k+1)T. The last step holds because for a flow with infinite demand, v(k)−v(k−1) is between 1/N CT and CT during an under-throttled period.

Similarly, the following lemma establishes the bound for the over-throttled case. Lemma 2: A node-backlogged flow in DVSR can be over throttled by at most (1−1/N)CT.

Proof: For a node backlogged flow i, over throttling occurs when the available fair rate increases. In other words, a flow will be over throttled when the average slope of v(t) increases from kT to (k+1)T. The worst case is when this occurs for N consecutive periods of duration T. For over-throttled situations, the server can potentially be idle. According to DVSR, the total throttled amount for time slot (k+1) will be v(k+1)−v(k)+(1−b(k))CT. Thus, assuming flow i enters the system at time 0, and denoting Oᵢ(N) as the over-throttling of flow i by slot N, we have that

$$\begin{matrix}{O}_{i} ( N ) \leq {\sum }_{k = 0}^{N - 1} ( min ( 1 , v ( k + 1 ) - v ( k ) + ( 1 - b ( k ) ) CT ) ) - \\ min ( 1 , ( v ( k ) - v ( k - 1 ) + ( 1 - b ( k - 1 ) ) CT ) ) \\ = ( min ( 1 , v ( N ) - v ( N - 1 ) + ) 1 - b ( N - 1 ) ) CT ) ) - \\ ( min ( 1 , v ( 0 ) - v ( - 1 ) + ( 1 - b ( - 1 ) ) CT ) ) \\ \leq ( C - \frac{1}{N} C ) T\end{matrix}$$

where the last step holds since (v(k)−v(k−1)+(1−b(k−1))CT is no less than 1/N CT.

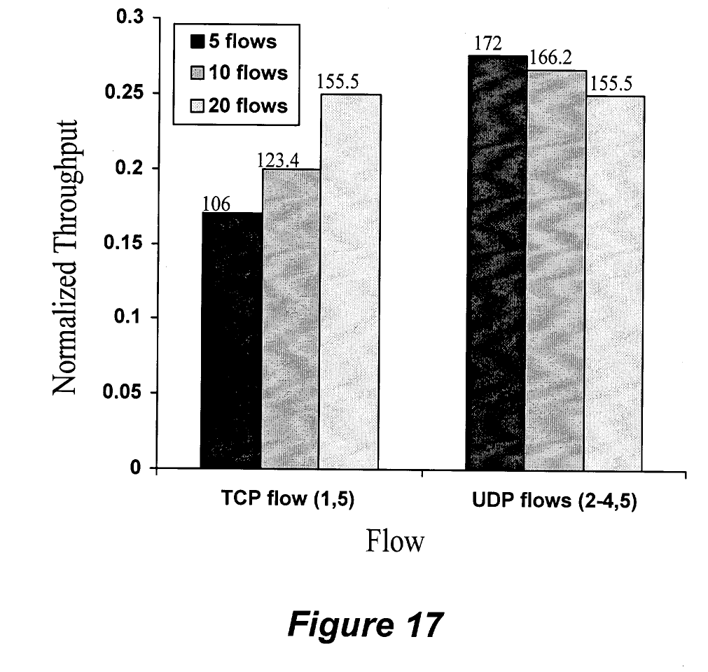

Lemmas 1 and 2 are illustrated in FIG. 15. Let f(t) (labelled “fair share”) denote the cumulative (averaged) fair share for flow i in each time slot given the requirements in this time slot. Let p(t) (labelled “rate controller”) denote the throttled traffic for flow i. Lemmas 1 and 2 specify that p(t) will be within the range of (1−1/N)CT of f(t).

Furthermore, let s(t) (labelled “service obtained”) denote the cumulative service for flow i. Then DVSR guarantees that if flow i has infinite demand, s(t) will not be less than f(t)−(1−1/N)CT. This can be justified as follows. As long as s(t) is less than p(t) (i.e., flow i is scheduler backlogged), flow i is guaranteed to obtain a fair share of service. Hence, the slope of s(t) will be no less than that of f(t). Otherwise, flow i would be in an over-throttled situation, and s(t)=p(t), and from Lemma 2, p(t) is no less than f(t)−(1−1/N)CT. Also notice that s(t) can be no larger than p(t), so that the service s(t) for flow i is within the range of (1−1/N)CT of f(t) as well.

From the above analysis, we can easily derive a fairness bound for two flows with infinite demand as follows.

Lemma 3: The service difference during any interval for two flows i and j with infinite demand is bounded by 2(C−1/N C)T under DVSR.

Proof: Observe that scheduler-backlogged flows will get no less than their fair shares due to the GPS scheduler. Therefore, for an under-throttled situation, each flow will receive no less than its fair share. Hence, unfairness only can occur during over-throttling. In such a scenario, a flow can only obtain additional service of its under-throttled amount. On the other hand, a flow can at most be under-served by its over-throttled amount. From Lemmas 1 and 2, this amount can at most 2(C−1/N C)T .

Finally, note that for the special case of T=0, the bound goes to zero so that DVSR achieves perfect fairness without any over/under throttling.

C. Discussion

The above methodology can be extended to multiple DVSR nodes in which each flow has one node buffer (at the ingress point) but multiple scheduler buffers. In this case, under-throttled traffic may be distributed among multiple scheduler buffers. On the other hand, for multiple nodes, to maximize spatial reuse, DVSR will rate control a flow at the ingress node using the minimum throttling rate from all the links. By substituting the single node-throttling rate with the minimum rate among all links, From Lemmas 1 and 2 can be shown to hold for the multiple node case as well.

Despite the simplified scenario for the above analysis, it does provide a simple if idealized fairness bound of 2(C−1/N C)T. For a 1 Gb/sec ring with 64 nodes and T=0.5 msec, this corresponds to a moderate maximum unfairness of 125 kB, i.e., 125 kB bounds the service difference between two infinitely backlogged flows under the above assumptions.

VII. SIMULATION EXPERIMENTS

In this section, we use simulations to study the performance of DVSR and provide comparisons with the RPR fairness algorithm. Moreover, as a baseline we compare with a Gigabit Ethernet (GigE) Ring that has no distributed bandwidth control algorithm and simply services arriving packets in first-in first-out order.

We divide our study into two parts. First, we study DVSR in the context of the basic RPR goals of achieving spatial reuse and fairness. We also explore interactions between TCP congestion control and DVSR's RIAS fairness objectives. Second, we compare the convergence times of DVSR and RPR.

We do not further consider scenarios with unbalanced traffic that result in oscillation and throughput degradation for RPR as treated in Section IV.

All simulation results are obtained with our publicly available ns-2 implementations of DVSR and RPR. Unless otherwise specified, RPR simulations refer to the default Aggressive Mode. We consider 622 Mbps links (OC-12), 200 kB buffer size, 1 kB packet size, and 0.1 msec link propagation delay between each pair of nodes. For a ring of N nodes, we set T to be 0.1 N msec such that one DVSR control packet continually circulates around the ring.

A. Fairness and Spatial Reuse

A.1 Fairness in the Parking Lot

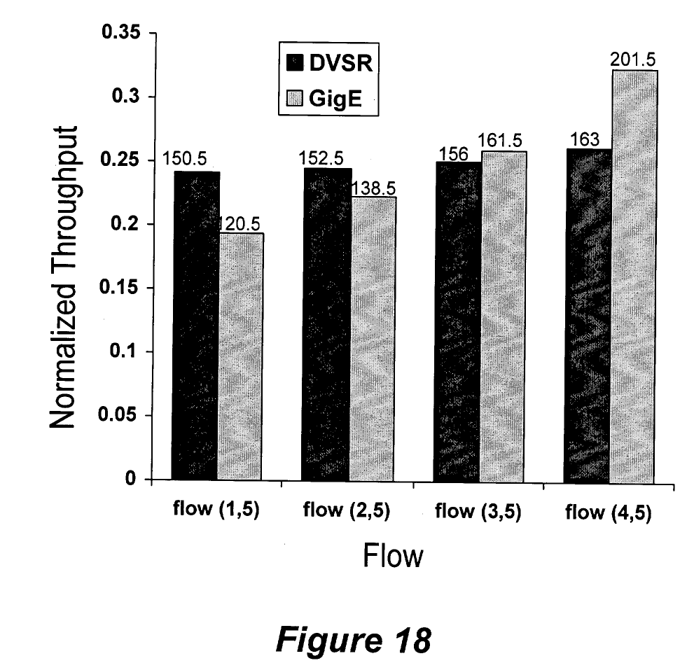

We first consider the parking lot scenario with a ten-node ring as depicted in FIG. 5 and widely studied in the RPR standardization process. Four constant-rate UDP flows (1,5), (2,5), (3,5), and (4,5) each transmit at an offered traffic rate of 622 Mbps, and we measure each flow's throughput at node 5. We perform the experiment with DVSR, RPR Aggressive Mode, RPR Conservative Mode, and GigE (for comparison, we set the GigE link rate to 622 Mbps) and present the results in FIG. 16. The figure depicts the average normalized throughput for each flow over the 5-second simulation, i.e., the total received traffic at node 5 divided by the simulation time. The labels above the bars represent the un-normalized throughput in Mbps.

We make the following observations about the figure. First, DVSR as well as RPR-AM and RPR-CM (not depicted) all achieve the correct RIAS fair rates (622/4) to within ±1%. In contrast, without the coordinated bandwidth control of the RPR algorithms, GigE fails to ensure fairness, with flow (4,5) obtaining 50% throughput share whereas flow (1,5) obtains 12.5%. For DVSR, we have repeated these and other experiments with Pareto on-off flows with various parameters and found identical average throughputs. The issue of variable rate traffic is more precisely explored with the TCP and convergence-time experiments below.

A.2 Performance Isolation for TCP Traffic

Unfairness among congestion-responsive TCP flows and non-responsive UDP flows is well established. However, suppose one ingress node transmits only TCP traffic whereas all other ingress nodes send high rate UDP traffic. The question is whether DVSR can still provide RIAS fair bandwidth allocation to the node with TCP flows, i.e., can DVSR provide inter-node performance isolation? An important issue is whether DVSR's reclaiming of unused capacity to achieve spatial reuse will hinder the throughput of the TCP traffic.

To answer this question, we consider the same parking lot topology of FIG. 5 and replace flow (1,5) with multiple TCP micro-flows, where each micro-flows is a long-lived TCP Reno flow (e.g., each representing a large file transfer). The remaining three flows are each constant rate UDP flows with rate 0.3 (186.6 Mbps).

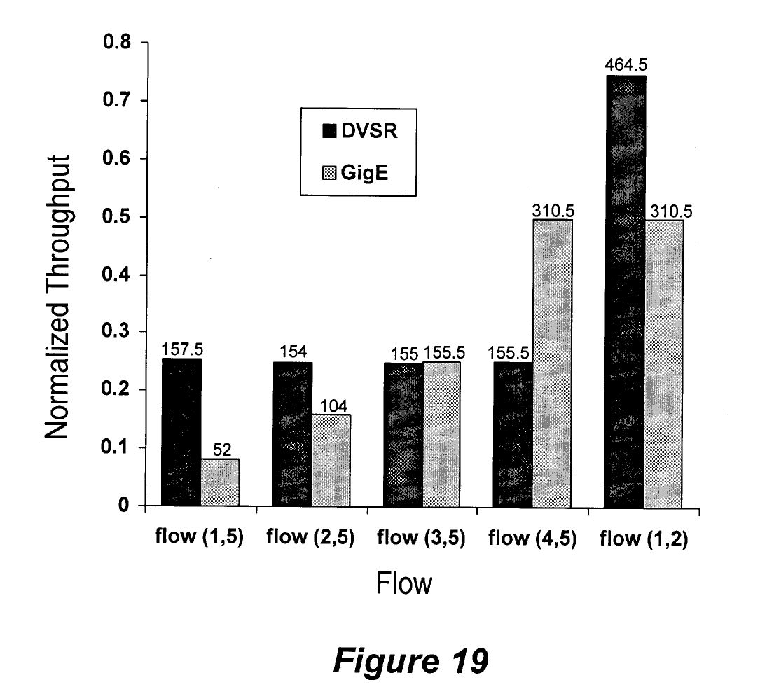

Ideally, the TCP traffic would obtain throughput 0.25, which is the RIAS fair rate between nodes 1 and 5. However, FIG. 17 indicates that whether this rate is achieved depends on the number of TCP micro-flows composing flow (1,5). For example, with only 5 TCP micro-flows, the total TCP throughput for flow (1,5) is 0.17, considerably above the pure excess capacity of 0. 1, but below the target of 0.25. The key reason is that upon detecting loss, the TCP flows reduce their rate providing further excess capacity for the aggressive UDP flows to reclaim. The TCP flows can eventually reclaim that capacity via linear increase of their rate in the congestion avoidance phase, but their throughput suffers on average. However, this effect is mitigated with additional aggregated TCP micro-flows such that for 20 or more micro-flows, the TCP traffic is able to obtain the same share of ring bandwidth as the UDP flows. The reason is that with highly aggregated traffic, loss events do not present the UDP traffic with a significant opportunity to reclaim excess bandwidth, and DVSR can fully achieve RIAS fairness. In contrast, for GigE and 20 TCP flows, the TCP traffic obtains a throughput share of 13%, significantly below its fair share of 25%. Thus, GigE rings cannot provide the node-level performance isolation provided by DVSR rings.

A.3 RIAS vs. Proportional Fairness for TCP Traffic

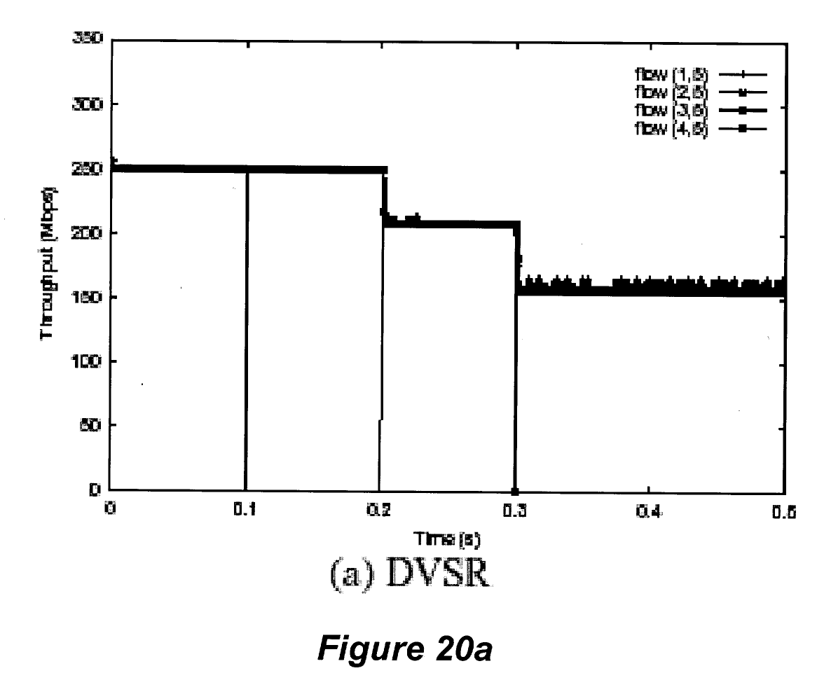

Next, we consider the case that each of the four flows in the parking lot is a single TCP micro-flow, and present the corresponding throughputs for DVSR and GigE in FIG. 18. As expected, with a GigE ring the flows with the fewest number of hops and lowest round trip time receive the largest bandwidth shares (cf. Section III). However, DVSR seeks to eliminate such spatial bias and provide all ingress nodes with an equal share. For DVSR and a single flow per ingress this is achieved to within approximately ±8%. This margin narrows to ±1% by 10 TCP micro-flows per ingress node (not shown). Thus, with sufficiently aggregated TCP traffic, a DVSR ring appears as a single node to TCP flows such that there is no bias to different RTTs.

A.4 Spatial Reuse in the Parallel Parking Lot

We now consider the spatial reuse scenario of the Parallel Parking Lot (FIG. 2) again with each flow offering traffic at the full link capacity (and hence, “balanced” traffic load). As described in Section III, the rates that achieve IA fairness while maximizing spatial reuse are 0.25 for all flows except flow (1,2) which should receive all excess capacity on link 1 and receive rate 0.75.

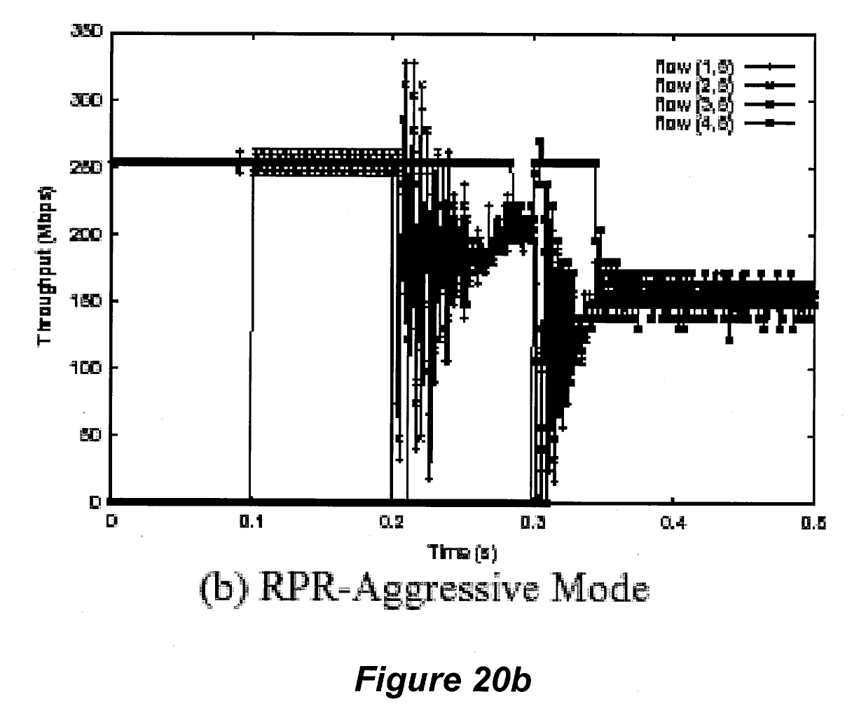

FIG. 19 shows that the average throughput for each flow for DVSR is within ±1% of the RIAS fair rates. RPR-AM and RPR-CM can also achieve these ideal rates within the same range when using the per-destination queue option. In contrast, as with the Parking Lot example, GigE favors downstream flows for the bottleneck link 4, and diverges significantly from the RIAS fair rates.

B. Convergence Time Comparison

In this experiment, we study the convergence times of the algorithms using the parking lot topology and UDP flows with normalized rate 0.4 (248.8 Mbps). The flows' starting times are staggered such that flows (1,5), (2,5), (3,5), and (4,5) begin transmission at times 0, 0.1, 0.2, and 0.3 seconds respectively.

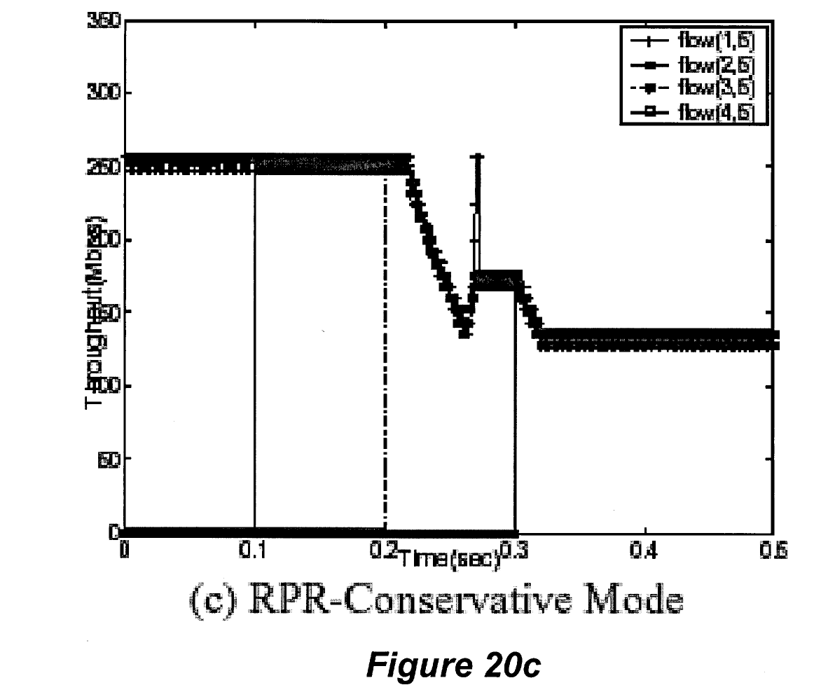

FIG. 20 depicts the throughput over windows of duration T for the three algorithms. Observe that DVSR converges in two ring times, i.e., 2 msec, whereas RPR-AM takes approximately 50 msec to converge, and RPR-CM takes about 18 msec. Moreover, the range of oscillation during convergence is significantly reduced for DVSR as compared to RPR. However, note that the algorithms have a significantly different number of control messages. RPR's control update interval is fixed to 0.1 msec so that RPR-AM and RPR-CM have received 180 and 500 respective control messages before converging. In contrast, DVSR has received 2 control messages.

For each of the algorithms, we also explore the sensitivity of the convergence time to the link propagation delay and feedback update time. We find that in both cases, the relationships are largely linear across the range of delays of interest for metropolitan networks. For example, with link propagation delays increased by a factor of 10 so that the ring time is 10 msec, DVSR takes approximately 22 msec to converge, slightly larger than 2T.

Finally, we note that RPR algorithms differ significantly in their ability to achieve spatial reuse with unbalanced traffic. As described in Section IV, RPR-AM and RPR-CM suffer from permanent oscillations and throughput degradation in cases of unbalanced traffic. In contrast DVSR achieves rates within 0.1% of the RIAS rates in simulations of all unbalanced scenarios presented in Section IV.

VIII. NETWORK PROCESSOR IMPLEMENTATION

The logic of each node's dynamic bandwidth allocation algorithm depicted in FIG. 3 may be implemented in custom hardware or in a programmable device such as a Network Processor (NP). We adopt the latter approach for its feasibility in an academic research lab as well as its flexibility to re-program and test algorithm variants. In this section, we describe our implementation of DVSR on a 2 Gb/sec Network Processor testbed. The DVSR algorithm is implemented in assembly language in the NP, utilizing the rate controllers and output queuing system of the NP in the same way that a hardware-only implementation would. The result allows an accurate emulation of DVSR behavior in a realistic environment. DVSR assembly language modules are available at http://www.ece.rice.edu/networks/DVSR.

A. NP Scenario

The DVSR implementation is centered around a Vitesse IQ2000™ NP, which is available from Vitesse Semiconductor Corporation of Camarillo, Calif. The IQ2000™ has four 200 MHz 32-bit RISC processing cores, each running four user contexts and including 4 KB of local memory. This allows up to 16 packets to be processed simultaneously by the NP. For communication interfaces, it has four 1 Gbps input and output ports with eight communication channels each, one of which is connected to an eight port 100 Mbps Ethernet MAC (also available from Viesse Semiconductor Corporation). Its memory capacity is 256 MB of external DRAM memory and 4 MB of external SRAM memory.

As described in Section V, the inputs to the DVSR bandwidth control algorithm are byte counts of arriving packets. In the NP, these byte counts are kept per destination for station traffic and per ingress for transit traffic, and are updated with each packet arrival and stored in SRAM. Using these measurements as inputs, the main steps to computing the IA fair bandwidth as given in Table I are written in a MIPS-like assembly language and performed by the RISC processors.

In our implementation, a single control packet circulates continuously around the ring. The control packet contains N 1-byte virtual-time fair rate values F₁, . . . , F_{N}, (N is 8 for our testbed and no larger than 256 for IEEE 802.17.) Upon receiving the control packet, node n stores the N bytes to local memory, updates its own value of Fₙ, and forwards the packet to the next upstream node. Using the received F₁, . . . , F_{N}, the control software computes the rate limiter values as given by Equation (10). The rate limiter values are therefore discretized to 256 possible values between 0 and the link capacity.

The output modules for each of the ports contain eight hardware queues per output channel, and each of these queues can be assigned a separate rate limit. Hence, for our 8-node ring, we use these hardware rate limiters to adaptively shape station traffic according to the fairness computation by writing the computed values of the station throttling rates to the output module.

Finally, on the data path, the DRAM of the NP contains packet buffers to hold data on the output queues, with a separate queue for transit vs. station traffic, and transit traffic scheduled alternately with the rate-limited station traffic.

Thus, considering the generic RPR node architecture of FIG. 3, the dynamic bandwidth allocation algorithm and forwarding logic is programmed on the NP, and all other components are hardware. On the transit path, the DVSR rate calculation algorithm is implemented in approximately 171 instructions. Moreover, the logic for nodes to compute their ingress rate controller values given a received control signal contains approximately 40 instructions, plus 37 to write the values to hardware. These operations are executed every T seconds. In our implementation, the NP also contains forwarding logic that increases the NP workload.

B. Testbed

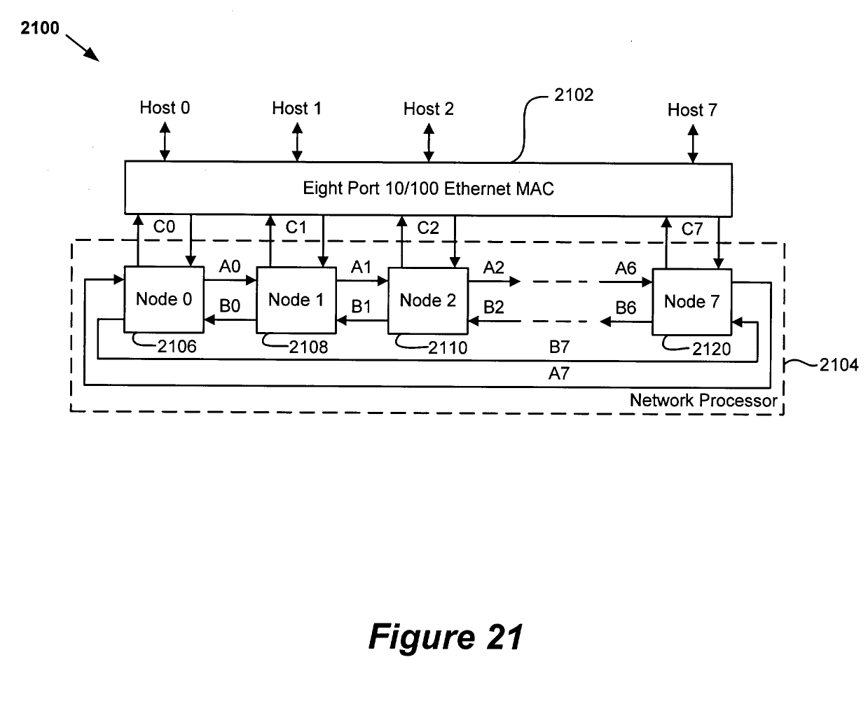

In our testbed configuration 2100, we emulate an eight-node ring node on a single NP 2104 using 24 interfaces operating at 100 Mb/s each as illustrated in FIG. 21. For each station connection, seven of the eight queues are assigned to the seven destination nodes on this ring as in FIG. 3. Transit traffic and control traffic occupy two additional queues.

As illustrated in FIG. 21, the eight Ethernet interfaces of the MAC 2102 are connected to port C provide the eight station connections. Each connection (C0 through C7) have corresponding nodes 0-7 (2106, 2108, 2110 through 2120) of the network processor 2104 as illustrated in FIG. 21. Ports A and B of the NP 2104 emulate the outer and inner rings respectively, and each channel represents one of the node-to-node connections. The arrival port and channel information is readily available for each packet so that the processor can determine which node to emulate for the current packet. For example, a packet arriving from port A on channel 0 has arrived from the inner ring connection of node 1 2108 (it has come from node 0 2106).

There are several factors in the emulation that may differ from the behavior of a true packet ring. Since the “connections” between nodes are wires within a single chip, the link propagation delay is negligible. In order to have increased latency as in a realistic scenario, the emulation includes a mechanism for delaying a packet by a tightly controlled amount of time before it is transmitted. In the experiments below, we have set these values such that the total ring propagation delay (and hence 7) is 0.6 msec.

Since all nodes reside in the same physical chip, all information (particularly the rate counters) is accessible to the emulation of all nodes. However, to ensure accurate emulation, all external memory accesses are indexed by the number of the current node, and all control information is read and written to the control packet only.

C. Results

We performed experiments in two basic scenarios: the parking lot and unbalanced traffic. For the parking lot experiments, we first use an 8-node ring and configure a parking lot scenario with 2 flows originating from nodes 1 and 2 and all with destination node 3. A Unix workstation is connected to each node with the senders running a UDP constant-rate traffic generation program and the receiver running tcpdump. In the experiment, each source node generates traffic at rate 58 Mbps such that the downstream link is significantly congested. Using on-chip monitoring tools, we found that the byte value of the control message was 0×7F in the second node's fields. Consequently, the upstream rates were all correctly set to 100 Mbps times 0×7F/0×FF and the fair rates were achieved within a narrow margin. Similarly, we performed experiments with a three-flow parking lot with the upstream flows generating traffic at rate 58 Mbps and the downstream flow generating traffic at 97 Mbps. The measured rate limiter values yielded the correct values of 0×55 for all three flows. The throughputs of the three flows were measured using tcpdump as 33.7, 33.7, and 32.6 Mbps. Next, we considered the case of unbalanced traffic problematic to RPR. Here, the upstream flow inputs traffic at nearly 100 Mbps and the downstream flow inputs traffic at rate 42 Mbps. The measured rate limiter value of the upstream flow was 0×94, correctly set to 58 Mbps.

In future work, we plan to configure the testbed with 1 Gb/sec interfaces and perform a broader set of experiments to study the impact of different workloads (including TCP flows), configurations (including the Parallel Parking Lot), and many of the scenarios explored in Section VII.

IX. RELATED WORK

The problem of devising distributed solutions to achieve high utilization, spatial reuse, and fairness is a fundamental one that must be addressed in many networking control algorithms. Broadly speaking, TCP congestion control achieves these goals in general topologies. However, as demonstrated in Section VII, a pure end-point solution to bandwidth allocation in packet rings results in spatial bias favoring nodes closer to a congested gateway. Moreover, end-point solutions do not provide protection against misbehaving flows. In addition, the goals of RPR are quite different than TCP: to provide fairness at the ring ingress-node granularity vs. TCP micro-flow granularity; to provide rate guarantees in addition to fairness, etc. Similarly, ABR rate control, and other distributed fairness protocols can achieve max-min fairness, and as with TCP, provides a natural mechanism for spatial reuse. However, packet rings provide a highly specialized scenario (fixed topology, small propagation delays, homogeneous link speeds, a small number of IA flows, etc.) so that algorithms can be highly optimized for this environment, and avoid the longer convergence times and complexities associated with end-to-end additive-increase multiplicative-decrease protocols.

The problem also arises in specialized scenarios such as wireless ad hoc networks. Due to the finite transmission range of wireless nodes, spatial reuse can be achieved naturally when different sets of communicating nodes are out of transmission range of one another. However, achieving spatial reuse and high utilization is at odds with balancing the throughputs of different flows and hence in achieving fairness. Distributed fairness and medium access algorithms to achieve max-min fairness and proportional fairness can be found in the prior art. While sharing similar core issues as RPR, such solutions are unfortunately quite specialized to ad hoc networks and are not applicable in packet rings, as the schemes exploit the broadcast nature of the wireless medium.

Achieving spatial reuse in rings is also a widely studied classical problem in the context of generalizing token ring protocols. A notable example is the MetaRing protocol, which we briefly describe as follows. MetaRing attained spatial reuse by replacing the traditional token of token rings with a ‘SAT’ (satisfied) message designed so that each node has an opportunity to transmit the same number of packets in a SAT rotation time. In particular, the algorithm has two key threshold parameters K and L, K=L. A station is allowed to transmit up to K packets on any empty slot between receipt of any two SAT messages (i.e., after transmitting K packets, a node cannot transmit further until receiving another SAT message.) Upon receipt of the SAT message, if the station has already transmitted L packets, it is termed “satisfied” and forwards the SAT message upstream. Otherwise, if the node has transmitted fewer than L packets and is backlogged, it holds the SAT message until L packets are transmitted. While providing significant throughput gains over token rings, the coarse granularity of control provided by holding a SAT signal limits such a technique's applicability to RPR. For example, the protocol's fairness properties were found to be highly dependent on the parameters K and L as well as the input traffic patterns; the SAT rotation time is dominated by the worst case link prohibiting full spatial reuse; etc.

X. CONCLUSIONS

In this discussion, we presented Distributed Virtual-time Scheduling in Rings, a dynamic bandwidth allocation algorithm targeted to achieve high utilization, spatial reuse, and fairness in packet rings. We showed through analysis, simulations, and implementation that DVSR overcomes limitations of the standard RPR algorithm and fully exploits spatial reuse, rapidly converges (typically within two ring times), and closely approximates our idealized fairness reference model, RIAS. Finally, we note that RIAS and the DVSR algorithm can be applied to any packet ring technology. For example, DVSR can be used as a separate fairness mode for RPR or as a control mechanism on top of Gigabit Ethernet used to ensure fairness in Metro Ethernet rings.

The invention, therefor, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is to be limited only by the spirit and scope of the appended claims, giving full cognizance to equivalents in all respects.

What is claimed is:

1. A method for allocating bandwidth in a multi-node packet ring network, comprising the steps of:
at each node of the packet ring network, calculating a proxy to obtain a fair rate, the proxy calculated on the basis of per-ingress measurements of traffic on the packet ring network;
distributing to upstream nodes of the packet ring network, the calculated proxy for the node; and
wherein each upstream node modulates the rate of its traffic according to the bandwidth demands of the downstream nodes of the packet ring network.

2. The method of claim 1, wherein each upstream node modulates the rate of its traffic according to the rate controller associated with each egress node.

3. The method of claim 1, wherein each upstream node modulates the rate of its traffic according to a single rate controller associated with each egress node.

4. The method of claim 1, further comprising the step of adjusting the rate of traffic at a node in response to update information concerning the bandwidth demands of the downstream nodes of the packet ring network.

5. The method of claim 1, wherein the multi-node packet ring network is a Gigabit Ethernet ring.

6. The method of claim 1, wherein the multi-node packet ring network is a 10 Gigabit Ethernet ring.

7. The method of claim 1, wherein the multi-node packet ring network is an Ethernet ring.

8. The method of claim 1, wherein the multi-node packet ring network is an IEEE 802.17 Resilient Packet Ring.

9. A method for determining the rate of traffic flow at a node of a multi-node packet ring network, comprising the steps of:
at each node, determining an aggregated traffic flow associated with the node by calculating a traffic flow rate on the basis of per-ingress measurements of traffic on the packet ring;
communicating the calculated traffic flow to at least one upstream node of the packet ring network; and
adjusting the traffic flow rate at each node on the basis of the downstream traffic demands of the packet ring network.

10. The method of claim 9, wherein the step of adjusting the traffic flow rate comprises the step of adjusting the traffic flow rate in response to an indication that downstream nodes of the packet ring network include at least one data stream originating in the downstream nodes of the packet ring network.

11. The method of claim 9, further comprising the step of periodically adjusting the traffic flow rates for at least one node according to updated information concerning the calculated traffic flow rates for said at least one node.

12. A multi-node packet ring network,
wherein each node of the network calculates a traffic flow rate on the basis of the data stream originating at the node; and
wherein each node of the network manages its traffic flow rate as a function of the traffic flow rates of downstream nodes in the packet ring network.

13. A method for establish ring ingress aggregated fairness in a multi-node packet ring network, comprising the steps of:
calculating, for at least one node of the packet ring network, a proxy, the proxy calculated on the basis of per-ingress measurements of traffic on the packet ring;
distributing to at least one upstream node of the packet ring network, the calculated proxy for the node; and
wherein each upstream node modulates the rate of its traffic according to the bandwidth demands of the downstream nodes of the packet ring network.

14. The method of claim 13, wherein the multi-node packet ring network is a Gigabit Ethernet ring.

15. The method of claim 13, wherein the multi-node packet ring network is an IEEE 802.17 Resilient Packet Ring.

16. A method for allocating bandwidth in a multi-node packet ring network, comprising the steps of:
constructing, by at least one of said nodes, a proxy to determine a fair rate of a aggregate flow granularity.

17. The method of claim 16, wherein said first granularity is an ingress aggregated flow granularity.

18. The method of claim 16, wherein said proxy provides a lower bound that is temporally aggregated over time for an ingress point.

19. The method of claim 18, wherein said proxy also provides a lower bound that is spatially aggregated over one or more traffic flows for said ingress point.

20. The method of claim 16, wherein said proxy emulates fair queuing.

21. The method of claim 20, wherein said proxy distributes information to at least one other of said nodes.

22. The method of claim 21, further comprising:
receiving by said node, information from one or more other nodes;
computing a fair rate for a downstream node based upon said information.

23. The method of claim 22, further comprising:
rate controlling said node's per-destination station traffic to a ring ingress aggregated with spatial reuse (RIAS) fairness rate.

24. The method of claim 20, further comprising:
throttling traffic, by said node, when said information indicates congestion in a downstream node.

25. The method of claim 20, wherein said information is a temporally aggregated summary of conditions.

26. The method of claim 24, wherein said node measures the number of arriving bytes from one or more ingress nodes over a pre-determined time interval.

27. The method of claim 26, further comprising:
computing a fair rate for said pre-determined time interval.

28. The method of claim 27, further comprising:
generating a control message, said control message containing said fair rate for said pre-determined time interval for said node.

29. The method of claim 28, further comprising:
sending said control message to another of said nodes.

30. The method of claim 28, further comprising:
determining a rate controller value.

31. The method of claim 30, wherein said step of determining comprises:
sub-allocating a per-link fair rate to the flow with at least one egress node.

32. The method of claim 16, wherein the multi-node packet ring network is a Gigabit Ethernet ring.

33. The method of claim 16, wherein the multi-node packet ring network is an IEEE 802.17 Resilient Packet Ring.

34. The method of claim 16, wherein said node has at least one rate controller, said rate controller constructed and arranged to receive ingress traffic.

35. The method of claim 34, wherein said node has a fair bandwidth allocator operative with said rate controller, said fair bandwidth allocator constructed and arranged to send a control message.

36. The method of claim 35, wherein said node has a traffic monitor operative with said rate controller and said fair bandwidth allocator.

37. The method of claim 32, wherein said node has at least one station transmit buffers operative with said rate controllers.

38. The method of claim 34, wherein said node has at least one transmit buffer.

39. The method of claim 34, wherein said node has:
at least one station transmit buffers operative with said rate controllers;
at least one transit buffer; and
a scheduler, operative with said station transit buffers and said transmit buffer, said scheduler further operative with said traffic monitor.

40. The method of claim 16, wherein said node comprises:
at least one rate controller, said rate controller constructed and arranged to receive ingress traffic;
a fair bandwidth allocator operative with said rate controller, said fair bandwidth allocator constructed and arranged to send a control message;
a traffic monitor operative with said rate controller and said fair bandwidth allocator;
at least one station transmit buffers operative with said rate controllers;
at least one transit buffers, said transit buffers constructed and arranged to receive transit in signals;
a scheduler operative with said traffic monitor, said scheduler constructed and arranged to receive signals from said station transmit buffers and said transit buffers, said scheduler further constructed and arranged to send transit out signals.

41. The method of claim 16, wherein the multi-node packet ring network is a 10 Gigabit Ethernet ring.

42. The method of claim 16, wherein the multi-node packet ring network is an Ethernet ring.
